(19) United States
(12) Patent Application Publication
(10) Pub. No.: US 2013/0142343 A1
(43) Pub. Date: Jun. 6, 2013

(54) SOUND SOURCE SEPARATION DEVICE, SOUND SOURCE SEPARATION METHOD AND PROGRAM

(71) Applicants: Shinya Matsui, Tokyo (JP); Yoji Ishikawa, Tokyo (JP); Katsumasa Nagahama, Tokyo (JP)

(72) Inventors: Shinya Matsui, Tokyo (JP); Yoji Ishikawa, Tokyo (JP); Katsumasa Nagahama, Tokyo (JP)

(73) Assignee: ASAHI KASEI KABUSHIKI KAISHA, Osaka (JP)

(21) Appl. No.: 13/699,421

(22) PCT Filed: Aug. 25, 2011
(86) PCT No.: PCT/JP2011/004734

§ 371 Date: Nov. 21, 2012

(30) Foreign Application Priority Data
Aug. 25, 2010 (JP) 2010-188737

(51) Int. Cl. G10K 11/178; H04R 29/00; H04R 3/00

(52) U.S. Cl. CPC G10K 11/178; H04R 3/00; H04R 29/005
USPC 381/56; 381/92; 381/71.1

(57) ABSTRACT

With conventional source separator devices, specific frequency bands are significantly reduced in environments where dispersed static is present that does not come from a particular direction, and as a result, the dispersed static may be filtered irregularly without regard to sound source separation results, giving rise to musical noise. In an embodiment of the present invention, by computing weighting coefficients which are in a complex conjugate relation, for post-spectrum analysis output signals from microphones (10, 11), a beam former unit (3) of a sound source separator device (1) thus carries out a beam former process for attenuating each sound source signal that comes from a region wherein the general direction of a target sound source is included and a region opposite to said region, in a plane that intersects a line segment that joins the two microphones (10, 11). A weighting coefficient computation unit (50) computes a weighting coefficient on the basis of the difference between power spectrum information calculated by power calculation units (40, 41).

### TECHNICAL FIELD

The present invention relates to a sound source separation device, a sound source separation method, and a program which use a plurality of microphones and which separate, from signals having a plurality of acoustic signals mixed, such as a plurality of voice signals output by a plurality of sound sources, and various environmental noises, a sound source signal arrived from a target sound source.

### BACKGROUND ART

When it is desired to record particular voice signals in various environments, the surrounding environment has various noise sources, and it is difficult to record only the signals of a target sound through a microphone. Accordingly, some noise reduction process or sound source separation process is necessary.

An example environment that especially needs those processes is an automobile environment. In an automobile environment, because of the popularization of cellular phones, it becomes typical to use a microphone placed distantly in the automobile for a telephone call using the cellular phone during driving. However, this significantly deteriorates the telephone speech quality because the microphone has to be located away from speaker's mouth. Moreover, an utterance is made in the similar condition when a voice recognition is performed in the automobile environment during driving. This is also a cause of deteriorating the voice recognition performance. Because of the advancement of the recent voice recognition technology, with respect to the deterioration of the voice recognition rate relative to stationary noises, most of the deteriorated performance can be recovered. It is, however, difficult for the recent voice recognition technology to address the deterioration of the recognition performance for simultaneous utterance by a plurality of utterers. According to the recent voice recognition technology, the technology of recognizing mixed voices of two persons simultaneously uttered is poor, and when a voice recognition device is in use, passengers other than an utterer are restricted so as not to utter, and thus the recent voice recognition technology restricts the action of the passengers.

Moreover, according to the cellular phone or a headset which is connected to the cellular phone to enable a hands-free call, when a telephone call is made under a background noise environment, the deterioration of the telephone speech quality also occurs.

In order to solve the above-explained technical issue, there are sound source separation methods which use a plurality of microphones. For example, Patent Document 1 discloses a sound source separation device which performs a beamformer process for attenuating respective sound source signals arrived from a direction symmetrical to a vertical line of a straight line interconnecting two microphones, and extracts spectrum information of the target sound source based on a difference in pieces of power spectrum. information calculated for a beamformer output.

When the sound source separation device of Patent Document 1 is used, the characteristic having the directivity characteristics not affected by the sensitivity of the microphone element is realized, and it becomes possible to separate a sound source signal from the target sound source from mixed sounds containing mixed sound source signals output by a plurality of sound sources without being affected by the variability in the sensitivity between the microphone elements.

### PRIOR ART DOCUMENT

### Patent Document

Patent Document 1: Japan Patent No. 4225430

### Non-Patent Documents

Non-patent Document 1: Y. Ephraim and D. Malah, “Speech enhancement using minimum mean-square error short-time spectral amplitude estimator”, IEEE Trans Acoust., Speech, Signal Processing, ASSP-32, 6, pp. 1109-1121, December 1984.
Non-patent Document 2: S. Gustafsson, P. Jax, and P. Vary, “A novel psychoacoustically motivated audio enhancement algorithm preserving background noise characteristics”, IEEE International Conference on Acoustics, Speech and Signal Processing, ICASSP '98, vol. 1, ppt. 397-400 vol. 1, 12-15 May 1998.

### SUMMARY OF THE INVENTION

### Problem to be Solved

According to the sound source separation device of Patent Document 1, however, when the difference between two pieces of power spectrum information calculated after the beamformer process is equal to or greater than a predetermined threshold, the difference is recognized as the target sound, and is directly output as it is. Conversely, when the difference between the two pieces of power spectrum information is less than the predetermined threshold, the difference is recognized as noises, and the output at the frequency band of those noises is set to be 0. Hence, when, for example, the sound source separation device of Patent Document 1 is activated in diffuse noise environments having an arrival direction uncertain like a road noises, a certain frequency band is largely cut. As a result, the diffuse noises are irregularly sorted into sound source separation results, becoming musical noises. Note that musical noises are the residual of canceled noises, and are isolated components over a time axis and a frequency axis. Accordingly, such musical noises are heard as unnatural and dissonant sounds.

Moreover, Patent Document 1 discloses that diffuse noises and stationary noises are reduced by executing a post-filter process before the beamformer process, thereby suppressing a generation of musical noises after the sound source separation. However, when a microphone is placed at a remote location or when a microphone is molded on a casing of a cellular phone or a headset, etc., the difference in sound level of noises input to both microphones and the phase difference thereof become large. Hence, if the gain obtained from the one microphone is directly applied to another microphone, the target sound may be excessively suppressed for each band, or noises may remain largely. As a result, it becomes difficult to sufficiently suppress a generation of musical noises.

The present invention has been made in order to solve the above-explained technical issues, and it is an object of the present invention to provide a sound source separation device, a sound source separation method, and a program which can sufficiently suppress a generation of musical noises without being affected by the placement of microphones.

### Solution to the Problem

To address the above technical issues, an aspect of the present invention provides a sound source separation device that separates, from mixed sounds containing mixed sound source signals output by a plurality of sound sources, a sound source signal from a target sound source, the sound source separation device includes: a first beamformer processing unit that performs, in a frequency domain using respective first coefficients different from each other, a product-sum operation on respective output signals by a microphone pair comprising two microphones into which the mixed sounds are input to attenuate a sound source signal arrived from a region opposite to a region including a direction of the target sound source with a plane intersecting with a line interconnecting the two microphones being as a boundary; a second beamformer processing unit which multiplies respective output signals by the microphone pair by a second coefficient in a relationship of complex conjugate with the first coefficients different from each other in the frequency domain, and which performs a product-sum operation on an obtained result in the frequency domain to attenuate a sound source signal arrived from the region including the direction of the target sound source with the plane being as the boundary; a power calculation unit which calculates first spectrum information having a power value for each frequency from a signal obtained through the first beamformer processing unit, and which further calculates second spectrum information having a power value for each frequency from a signal obtained through the second beamformer processing unit; a weighting-factor calculation unit that calculates, in accordance with a difference in the power values for each frequency between the first spectrum information and the second spectrum information, a weighting factor for each frequency to be multiplied by the signal obtained through the first beamformer processing unit; and a sound source separation unit that separates, from the mixed sounds, the sound source signal from the target sound source based on a multiplication result of the signal obtained through the first beamformer processing unit by the weighting factor calculated by the weighting-factor calculation unit.

Moreover, another aspect of the present invention provides a sound source separation method executed by a sound source separation device comprising a first beamformer processing unit, a second beamformer processing unit, a power calculation unit, a weighting-factor calculation unit, and a sound source separation unit, the method includes: a first step of causing the first beamformer processing unit to perform, in a frequency domain using respective first coefficients different from each other, a product-sum operation on respective output signals by a microphone pair comprising two microphones into which mixed sounds containing mixed sound signals output by a plurality of sound sources are input to attenuate a sound source signal arrived from a region opposite to a region including a direction of a target sound source with a plane intersecting with a line interconnecting the two microphones being as a boundary; a second step of causing the second beamformer processing unit to multiply respective output signals by the microphone pair by a second coefficient in a relationship of complex conjugate with the first coefficients different from each other in the frequency domain, and to perform a product-sum operation on an obtained result in the frequency domain to attenuate a sound source signal arrived from the region including the direction of the target sound source with the plane being as the boundary; a third step of causing the power calculation unit to calculate first spectrum information having a power value for each frequency from a signal obtained through the first step, and to further calculate second spectrum information having a power value for each frequency from a signal obtained through the second step; a fourth step of causing the weighting-factor calculation unit to calculate, in accordance with a difference in the power values for each frequency between the first spectrum information and the second spectrum information, a weighting factor for each frequency to be multiplied by the signal obtained through the first step; and a fifth step of causing the sound source separating unit to separate, from the mixed sounds, a sound source signal from the target sound source based on a multiplication result of the signal obtained through the first step by the weighting factor calculated through the fourth step.

Furthermore, the other aspect of the present invention provides a sound source separation program that causes a computer to execute: a first process step of performing, in a frequency domain using respective first coefficients different from each other, a product-sum operation on respective output signals by a microphone pair comprising two microphones into which mixed sounds containing mixed sound signals output by a plurality of sound sources are input to attenuate a sound source signal arrived from a region opposite to a region including a direction of a target sound source with a plane intersecting with a line interconnecting the two microphones being as a boundary; a second process step of multiplying respective output signals by the microphone pair by a second coefficient in a relationship of complex conjugate with the first coefficients different from each other in the frequency domain, and performing a product-sum operation on an obtained result in the frequency domain to attenuate a sound source signal arrived from the region including the direction of the target sound source with the plane being as the boundary; a third process step of calculating first spectrum information having a power value for each frequency from a signal obtained through the first process step, and further calculating second spectrum information having a power value for each frequency from a signal obtained through the second process step; a fourth process step of calculating, in accordance with a difference in the power values for each frequency between the first spectrum information and the second spectrum information, a weighting factor for each frequency to be multiplied by the signal obtained through the first process step; and a fifth process step of separating, from the mixed sounds, a sound source signal from the target sound source based on a multiplication result of the signal obtained through the first process step by the weighting factor calculated through the fourth process step.

According to those configurations, the generation of musical noises can be suppressed in an environment where, in particular, diffusible noises are present, while at the same time, the sound source signal from the target sound source can be separated from mixed sounds containing mixed sound source signals output by the plurality of sound sources.

### Advantageous Effects of the Invention

It becomes possible to sufficiently suppress a generation of musical noises while maintaining the effect of Patent Document 1.

### BRIEF DESCRIPTION OF THE DRAWINGS

FIG. 1 is a diagram showing a configuration of a sound source separation system according to a first embodiment;

FIG. 2 is a diagram showing a configuration of a beamformer unit according to the first embodiment;

FIG. 3 is a diagram showing a configuration of a power calculation unit;

FIG. 4 is a diagram showing process results of microphone input signals by the sound source separation device of Patent Document 1 and the sound source separation device according to the first embodiment of the present invention;

FIG. 5 is an enlarged view of apart of the process results shown in FIG. 4;

FIG. 6 is a diagram showing a configuration of noise estimation unit;

FIG. 7 is a diagram showing a configuration of a noise equalizer;

FIG. 8 is a diagram showing another configuration of the sound source separation system according to the first embodiment;

FIG. 9 is a diagram showing a configuration of a sound source separation system according to a second embodiment;

FIG. 10 is a diagram showing a configuration of a control unit;

FIG. 11 is a diagram showing an example configuration of a sound source separation system according to a third embodiment;

FIG. 12 is a diagram showing an example configuration of the sound source separation system according to the third embodiment;

FIG. 13 is a diagram showing an example configuration of the sound source separation system according to the third embodiment;

FIG. 14 is a diagram showing a configuration of a sound source separation system according to a fourth embodiment;

FIG. 15 is a diagram showing a configuration of a directivity control unit;

FIG. 16 is a diagram showing directivity characteristics of the sound source separation device of the present invention;

FIG. 17 is a diagram showing another configuration of the directivity control unit;

FIG. 18 is a diagram showing directivity characteristics of the sound source separation device of the present invention when provided with a target sound correcting unit;

FIG. 19 is a flowchart showing an example process executed by the sound source separation system;

FIG. 20 is a flowchart showing the detail of a process by the noise estimation unit;

FIG. 21 is a flowchart showing the detail of a process by the noise equalizer;

FIG. 22 is a flowchart showing the detail of a process by a residual-noise-suppression calculation unit;

FIG. 23 is a diagram showing a graph for a comparison between near-field sound and far-field sound with respect to an output value by a beamformer 30 (microphone pitch: 3 cm);

FIG. 24 is a diagram showing a graph for a comparison between near-field sound and far-field sound with respect to an output value by the beamformer 30 (microphone pitch: 1 cm);

FIG. 25 is a diagram showing an interface of sound source separation by the sound source separation device of Patent Document 1; and

FIG. 26 is a diagram showing the directivity characteristics of the sound source separation device of Patent Document 1.

### DESCRIPTION OF EMBODIMENTS

Embodiments of the present invention will now be explained with reference to the accompanying drawings.

### First Embodiment

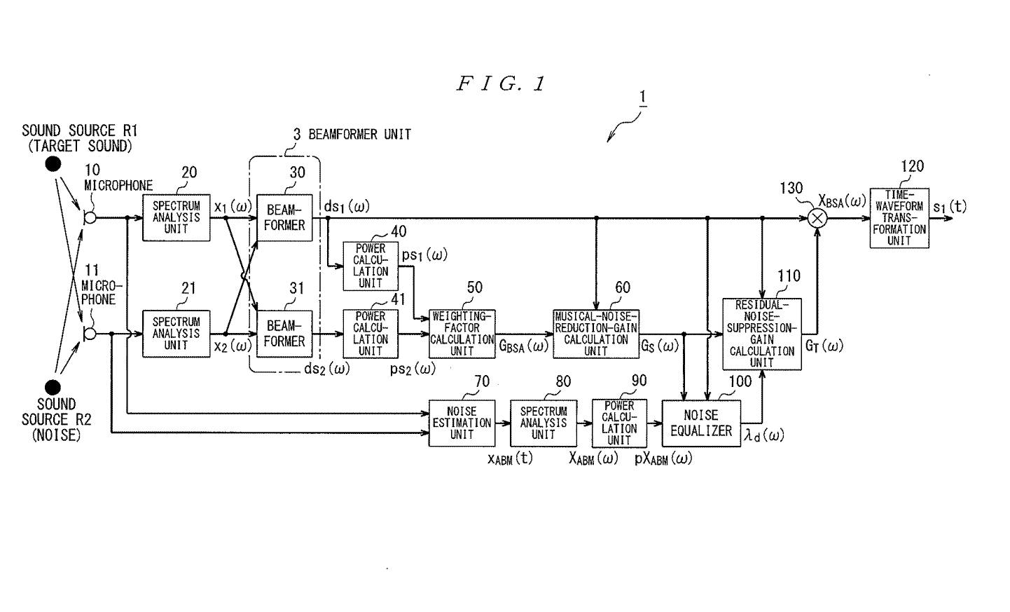

FIG. 1 is a diagram showing a basic configuration of a sound source separation system according to a first embodiment. This system includes two micro-phones (hereinafter, referred to as “microphones”) 10 and 11, and a sound source separation device 1. The explanation will be given below for the embodiment in which the number of the microphones is two, but the number of the microphones is not limited to two as long as at least equal to or greater than two microphones are provided.

The sound source separation device 1 includes hardware, not illustrated, such as a CPU which controls the whole sound source separation device and which executes arithmetic processing, a ROM, a RAM, and a storage device like a hard disk device, and also software, not illustrated, including a program and data, etc., stored in the storage device. Respective functional blocks of the sound source separation device 1 are realized by those hardware and software.

The two microphones 10 and 11 are placed on a plane so as to be distant from each other, and receive signals output by two sound sources R1 and R2. At this time, those two sound sources R1 and R2 are each located at two regions (hereinafter, referred to as “right and left of a separation surface”) divided with a plane (hereinafter, referred to as separation surface) intersecting with a line interconnecting the two microphones 10 and 11, but that the sound sources are not necessarily positioned at symmetrical locations with respect to the separation surface. According to this embodiment, the explanation will be given of an example case in which the separation surface is a plane intersecting with a plane containing therein the line interconnecting the two microphones 10 and 11 at right angle, and is a plane passing through the midpoint of the line.

It is presumed that the sound output by the sound source R1 is a target sound to be obtained, and the sound output by the sound source R2 is noises to be suppressed (the same is true throughout the specification). The number of noises is not limited to one, and multiple numbers of noises may be suppressed. However, it is presumed that the direction of the target sound and those of the noises are different.

The two sound source signals obtained from the microphones 10 and 11 are subjected to frequency analysis for each microphone output by spectrum analysis units 20 and 21, respectively, and in a beamformer unit 3, the signals having undergone the frequency analysis are filtered by beamformers 30 and 31, respectively, having null-points formed at the right and left of the separation surface. Power calculation units 40 and 41 calculate respective powers of filter outputs. Preferably, the beamformers 30 and 31 have null-points formed symmetrically with respect to the separation surface in the right and left of the separation surface.

(Beamformer Unit)

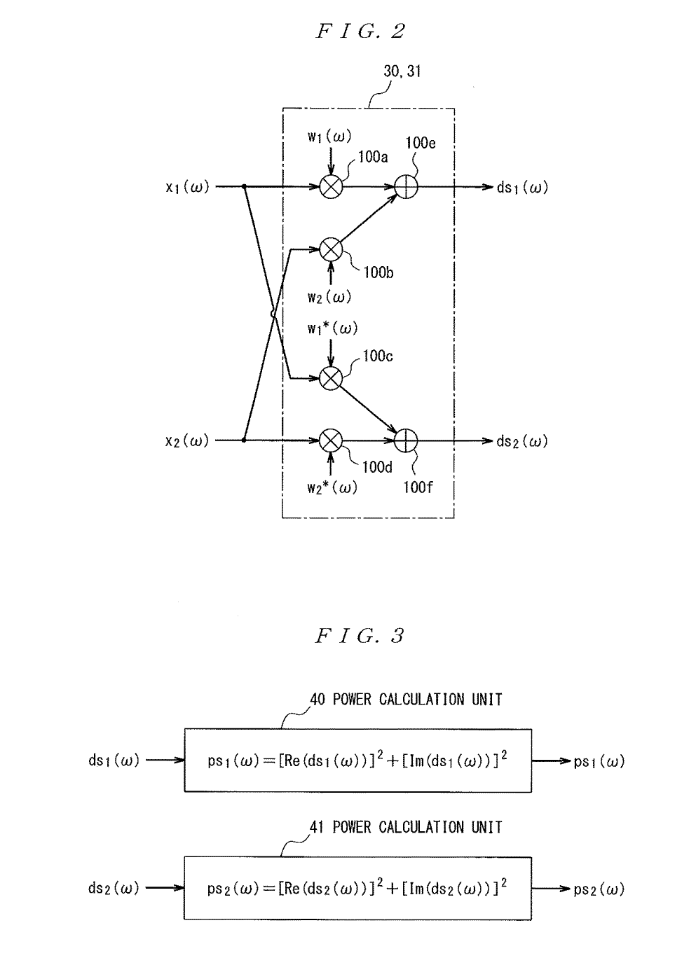

First, with reference to FIG. 2, an explanation will be given of the beamformer unit 3 configured by the beamformers 30 and 31. With signals x₁(ω) and x₂(ω) decomposed for each frequency component by the spectrum analysis unit 20 and the spectrum analysis unit 21, respectively, being as input, multipliers 100a, 100b, 100c, and 100d respectively perform multiplication with filter coefficients w₁(ω),w₂(ω),w₁*(ω), and w₂*(ω) (where * indicates a relationship of complex conjugate).

Adders 100e and 100f add respective two multiplication results and output filtering process results ds₁(ω) and ds₂(ω) as respective outputs. Provided that a gain with respect to a target direction θ₁ is 1, a filter vector of the beamformer 30 forming a null-point in another direction θ₂ is W₁(ω, θ₁, θ₂)=[w₁(ω, θ₁, θ₂) w₂(ω, θ₁, θ₂)]^{T}, and an observation signal is X(ω, θ₁, θ₂)=[x₁(ω, θ₁, θ₂), x₂(ω, θ₁, θ₂)]^{T}, the output ds₁(ω) of the beamformer 30 can be obtained from a following formula where T indicates a transposition operation, and H indicates a conjugate transposition operation.

ds₁(ω)=W₁(ω,θ₁,θ₂)^{H}X(ω,θ₁θ₂) (1)

Moreover, when a filter vector of the beamformer 31 is W₂(ω, θ₁, θ₂)=[w₁* (*ω, θ₁, θ₂), w₂* (ω, θ₁, θ₂)]^{T}, the output ds₂(ω) of the beamformer 31 can be obtained from a following formula.

ds₂(ω)=W₂(ω,θ₁,θ₂)^{H}X(ω,θ₁θ₂) (2)

The beamformer unit 3 uses the complex conjugate filter coefficients, and forms null-points at symmetrical locations with respect to the separation surface in this manner. Note that ω indicates an angular frequency, and satisfies a relationship ω=2πf with respect to a frequency f.

(Power Calculation Unit)

Next, an explanation will be given of power calculation units 40 and 41 with reference to FIG. 3. The power calculation units 40 and 41 respectively transform the outputs ds₁(ω) and ds₂(ω) of the beamformer 30 and the beamformer 31 into pieces of power spectrum information ps₁(ω) and ps₂(ω) through following calculation formulae.

ps₁(ω)=[Re(ds₁(ω))]²+[Im(ds₁(ω))]² (3)

ps₂(ω)=[Re(ds₂(ω))]²+[Im(ds₂(ω))]² (4)

(Weighting-Factor Calculation Unit)

Respective outputs ps₁(ω) and ps₂(ω) of the power calculation units 40 and 41 are used as two inputs into a weighting-factor calculation unit 50. The weighting-factor calculation unit 50 outputs a weighting factor G_{BSA}(ω) for each frequency with the pieces of power spectrum information that are the outputs by the two beamformers 30 and 31 being as inputs.

The weighting factor G_{BSA}(ω) is a value based on a difference between the pieces of the power spectrum information, and as an example weighting factor G_{BSA}(ω), an output value of a monotonically increasing function having a domain of a value which indicates, when a difference between ps₁(ω) and ps₂(ω) is calculated for each frequency, and the value of ps₁(ω) is larger than that of ps₂(ω), a value obtained by dividing the square root of the difference between ps₁(ω) and ps₂(ω) by the square root of ps₁(ω), and which also indicates 0 when the value of ps₁(ω) is equal to or smaller than that of ps₂(ω). When the weighting factor G_{BSA}(ω) is expressed as a formula, a following formula can be obtained.

$${G}_{BSA} ( ω ) = F ( \sqrt{\frac{max ( {ps}_{1} ( ω ) - {ps}_{2} ( ω ) , 0 )}{{ps}_{1} ( ω )}} ) \qquad ( 5 )$$

In the formula (5), max(a, b) means a function that returns a larger value between a and b. Moreover, F(x) is a weakly increasing function that satisfies dF(x)/dx≧0 in a domain x≧0, and examples of such a function are a sigmoid function and a quadratic function.

G_{BSA}(ω)ds₁(ω) will now be discussed. As is indicated by the formula (1), ds₁(ω) is a signal obtained through a linear process on the observation signal X(ω, θ₁, θ₂). On the other hand, G_{BSA}(ω)ds₁(ω) is a signal obtained through a non-linear process on ds₁(ω).

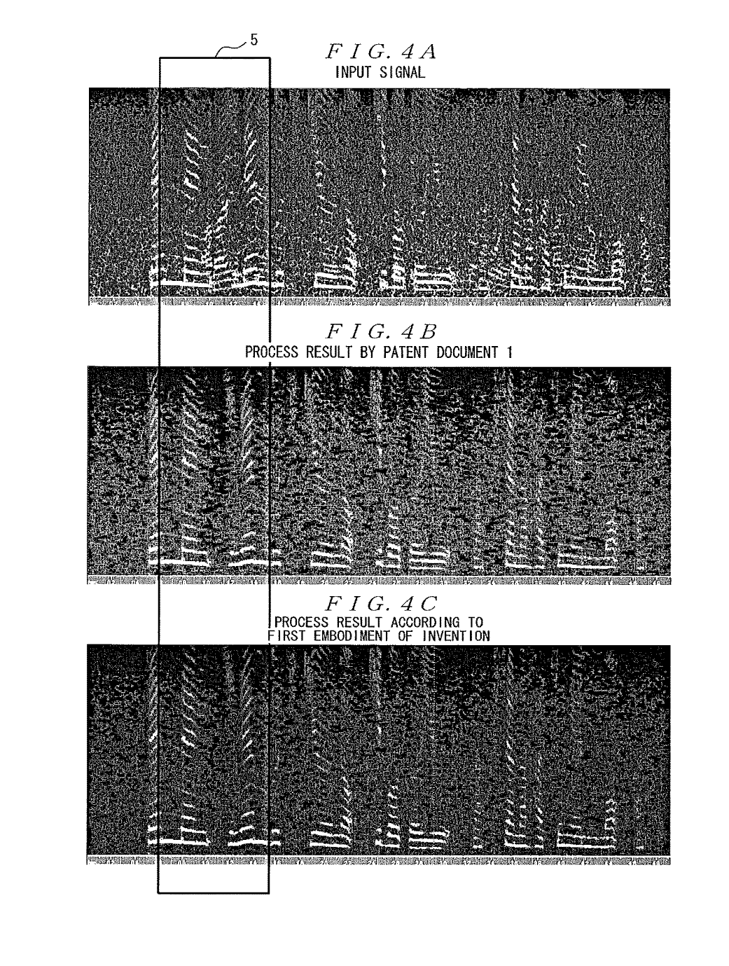

FIG. 4A shows an input signal from a microphone, FIG. 4B shows a process result by the sound source separation device of Patent Document 1, and FIG. 4C shows a process result by the sound source separation device of this embodiment. That is, FIGS. 4B and 4C show example G_{BSA}(ω) ds₁(ω) through a spectrogram. For the monotonically increasing function F(x) of the sound source separation device of this embodiment, a sigmoid function was applied. In general, a sigmoid function is a function expressed as 1/(1+exp(a−bx)), and in the process result shown in FIG. 4C, a=4 and b=6.

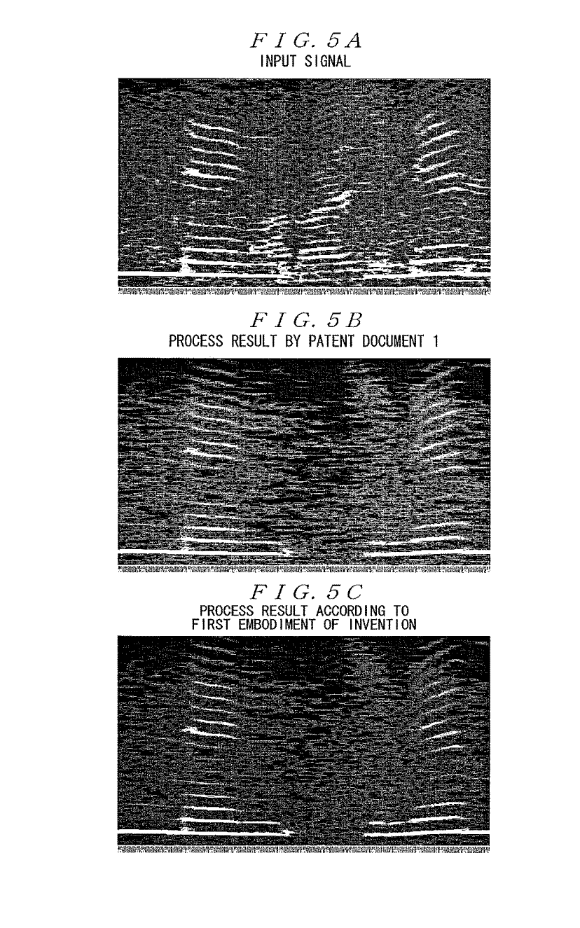

Moreover, FIG. 5 is an enlarged view showing a part (indicated by a number 5) of the spectrogram of FIGS. 4A to 4C in a given time slot in an enlarged manner in the time axis direction. When a spectrogram indicating a process result (FIG. 5B) of the input sound (FIG. 5A) by the sound source separation device of Patent Document 1 is observed, it becomes clear that energies of noise components are eccentrically located in the time direction and the frequency direction in comparison with the process result (FIG. 5C) by the sound source separation device of this embodiment, and musical noises are generated.

In contrast, with respect to the noise components of the spectrogram of FIG. 4C, unlike the input signal, the energies of the noise components are not eccentrically located in the time direction and the frequency direction, and musical noises are little.

(Musical-Noise-Reduction-Gain Calculation Unit)

G_{BSA}(ω) dS₁(ω) is a sound source signal from a target sound source and having the musical noises sufficiently reduced, but in the cases of noises like diffusible noises arrived from various directions, G_{BSA}(ω) that is a non-liner process has a value largely changing for each frequency bin or for each frame, and is likely to generate musical noises. Hence, the musical noises are reduced by adding a signal before the non-linear process having no musical noises to the output after the non-linear process. More specifically, a signal is calculated which is obtained by adding a signal X_{BSA} (ω) obtained by multiplying the output ds₁(ω) of the beamformer 30 by the output G_{BSA}(ω) and the output ds₁(ω) of the beamformer 30 at a predetermined ratio.

Moreover, there is another method which recalculates a gain for multiplication of the output ds₁(ω) of the beamformer 30. The musical-noise-reduction-gain calculation unit 60 recalculates a gain G_{S}(ω) for adding a signal X_{BSA}(ω) obtained by multiplying the output ds₁(ω) of the beamformer 30 by the output G_{BSA}(ω) of the weighting-factor calculation unit 50 and the output ds₁(ω) of the beamformer 30 at a predetermined ratio.

A result (X_{S}(ω)) obtained by mixing X_{BSA}(ω) with the output ds₁(ω) of the beamformer 30 at a certain ratio can be expressed by a following formula. Note that γ_{S} is a weighting factor setting the ratio of mixing, and is a value larger than 0 and smaller than 1.

Xₛ(ω)=γ_{S}X_{BSA}(ω)+(1−γ_{S})ds₁(ω) (6)

Moreover, when the formula (6) is expanded to a form of multiplying the output ds₁(ω) of the beamformer 30 by the gain, a following formula can be obtained.

$$\begin{matrix}{X}_{S} ( ω ) = {ds}_{1} ( ω ) \{ {γ}_{S} ( {G}_{BSA} ( ω ) - 1 ) + 1 \} \\ = {ds}_{1} ( ω ) {G}_{S} ( ω )\end{matrix} \qquad ( 7 )$$

That is, the musical-noise-reduction-gain calculation unit 60 can be configured by a subtractor that subtracts 1 from G_{BSA}(ω), a multiplier that multiplies the subtraction result by the weighting factor γₛ, and an adder that adds 1 to the multiplication result. That is, according to such configuration, the gain value G_{S}(ω) having the musical noises reduced is recalculated as a gain to be multiplied by the output ds₁(ω) of the beamformer 30.

A signal obtained based on the multiplication result of the gain value G_{S}(ω) and the output ds₁(ω) of the beamformer 30 is a sound source signal from the target sound source and having the musical noises reduced in comparison with G_{BSA}(ω) ds₁(ω). This signal is transformed into a time domain signal by a time-waveform transformation unit 120 to be discussed later, and may output as a sound source signal from the target sound source.

Meanwhile, since the gain value G_{S}(ω) becomes always larger than G_{BSA}(ω), musical noises are reduced, while at the same time, the noise components are increased. Hence, in order to suppress residual noises, a residual-noise-suppression-gain calculation unit 110 is provided at the following stage of the musical-noise-reduction-gain calculation unit 60, and a further optimized gain value is recalculated.

Moreover, the residual noises of X_{S}(ω) obtained by multiplying the output ds₁(ω) of the beamformer 30 by the gain G_{S}(ω) calculated by the musical-noise-reduction-gain calculation unit 60 contain non-stationary noises. Hence, in order to enable estimation of such non-stationary noises, in a calculation of estimated noises utilized by the residual-noise-suppression-gain calculation unit 110, a blocking matrix unit 70 and a noise equalizer 100 to be discussed later are applied.

(Noise Estimation Unit)

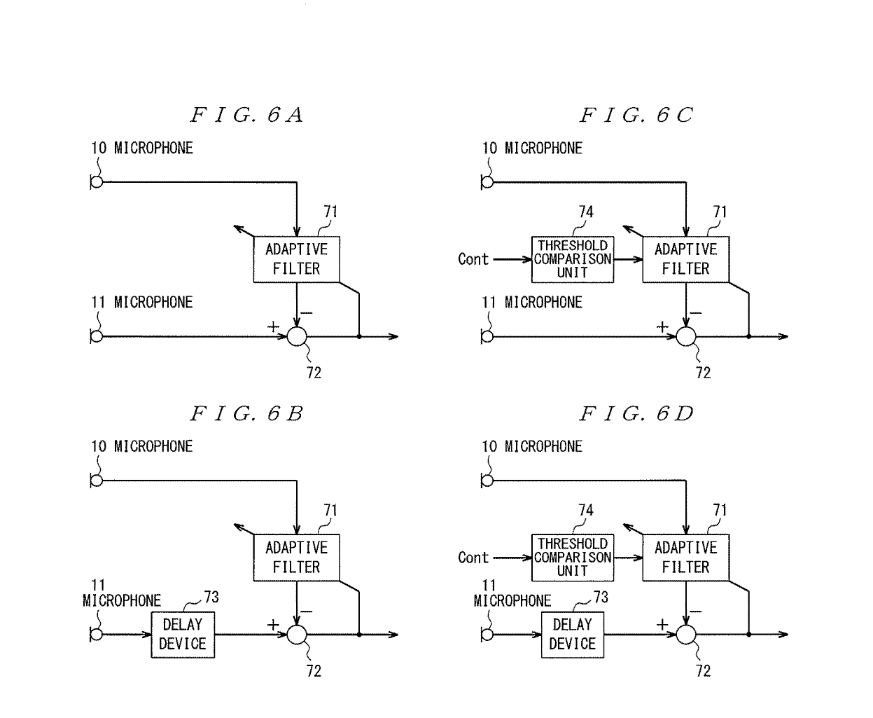

FIGS. 6A to 6D are block diagrams of a noise estimation unit 70. The noise estimation unit 70 performs adaptive filtering on the two signals obtained through the microphones 10 and 11, and cancels the signal components that are the target sound from the sound source R1, thereby obtaining only the noise components.

It is presumed that a signal from the sound source R1 is S(t). The sound from the sound source R1 reaches the microphone 10 faster than the sound from the sound source R2. It is also presumed that signals of sounds from other sound sources are nⱼ(t), and those are defined as noises. At this time, an input x₁(t) of the microphone 10 and an input x₂(t) of the microphone 11 can be expressed as follows.

$$\begin{matrix}{x}_{1} ( t ) = {h}_{s 1} s ( t ) + {\sum }_{j = 1}^{K} {h}_{nj 1} {n}_{j} ( t ) & ( 9 - 1 ) \\ {x}_{2} ( t ) = {h}_{s 2} s ( t ) + {\sum }_{j = 1}^{K} {h}_{nj 2} {n}_{j} ( t ) & ( 9 - 2 )\end{matrix}$$

where:

hₛ₁ is a transfer function of the target sound to the microphone 10;

hₛ₂ is a transfer function of the target sound to the microphone 11;

hₙⱼ₁ is a transfer function of noises to the microphone 10; and

hₙⱼ₂ is a transfer function of noises to the microphone 11.

An adaptive filter 71 shown in FIG. 6 convolves the input signal of the microphone 10 with an adaptive filtering coefficient, and calculates pseudo signals similar to the signal components obtained through the microphone 11. Next, a subtractor 72 subtracts the pseudo signal from the signal from the microphone 11, and calculates an error signal (a noise signal) in the signal from the sound source R1 and included in the microphone 11. An error signal x_{ABM}(t) is the output signal by the noise estimation unit 70.

x_{ABM}(t)=x₂(t)−H^{T}(t)·x₁(t) (10)

Furthermore, the adaptive filter 71 updates the adaptive filtering coefficient based on the error signal. For example, NLMS (Normalized Least Mean Square) is applied for the updating of an adaptive filtering coefficient H(t). Moreover, the updating of the adaptive filter may be controlled based on an external VAD (Voice Activity Detection) value or information from a control unit 160 to be discussed later (FIGS. 6C and 6D). More specifically, for example, when a threshold comparison unit 74 determines that the control signal from the control unit 160 is larger than a predetermined threshold, the adaptive filtering coefficient H(t) may be updated. Note that a VAD value is a value indicating whether or not a target voice is in an uttering condition or from a non-uttering condition. Such a value may be a binary value of On/Off, or may be a probability value having a certain range indicating the probability of an uttering condition.

At this time, if the target sound and noises are non-correlated, the output x_{ABM}(t) of the noise estimation unit 70 can be calculated as follow.

$${x}_{ABM} ( t ) = {\sum }_{j = 1}^{K} {h}_{nj 2} {n}_{j} ( t ) - {H}^{T} ( t ) \cdot {\sum }_{j = 1}^{K} {h}_{nj 1} {n}_{j} ( t ) + {( {h}_{s 2} {h}_{s 1}^{- 1} - H ( t ) )}^{T} {h}_{s 1} s ( t ) \qquad ( 11 )$$

At this time, if a transfer function which suppresses the target sound can be estimated, the output x_{ABM}(t) can be expressed as follow.

(It is presumed that a transfer function H(t)→hₛ₂hₛ₁⁻¹ which suppresses a target sound can be estimated.)

$${x}_{ABM} ( t ) = {\sum }_{j = 1}^{K} {h}_{nj 2} {n}_{j} ( t ) - ( {h}_{s 2} {h}_{s 1}^{- 1} ) τ \cdot {\sum }_{j = 1}^{K} {h}_{nj 1} {n}_{i} ( t ) \qquad ( 12 )$$

According to the above-explained operations, the noise components from directions other than the target sound direction can be estimated to some level. In particular, unlike the Griffith-Jim technique, no fixed filter is used, and thus the target sound can be suppressed robustly depending on a difference in the microphone gain. Moreover, as shown in FIGS. 6B to 6D, by changing a DELAY value of the filter in a delay device 73, the spatial range where sounds are determined as noises becomes controllable. Accordingly, it becomes possible to narrow down or expand the directivity depending on the DELAY value.

As the adaptive filter, in addition to the above-explained filter, ones which are robust to the difference in the gain characteristic of the microphone can be used.

Moreover, with respect to the output by the noise estimation unit 70, a frequency analysis is performed by a spectrum analysis unit 80, and power for each frequency bin is calculated by a noise power calculation unit 90. Moreover, the input to the noise estimation unit 70 may be a microphone input signal having undergone a spectrum analysis.

(Noise Equalizer)

The noise quantity contained in X_{ABM}(ω) obtained by performing a frequency analysis on the output by the noise estimation unit 70 and the noise quantity contained in the signal X_{S}(ω) obtained by adding the signal X_{BSA}(ω) which is obtained by multiplying the output ds₁(ω) of the beamformer 30 by the weighting factor G_{BSA}(ω) and the output ds₁(ω) of the beamformer 30 at a predetermined ratio have a similar spectrum but have a large difference in the energy quantity. Hence, the noise equalizer 100 performs correction so as to make both energy quantities consistent with each other.

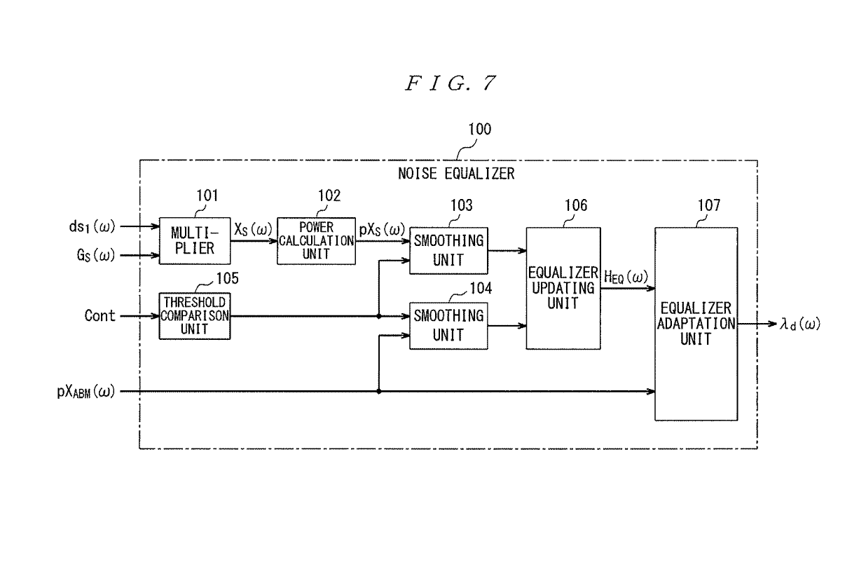

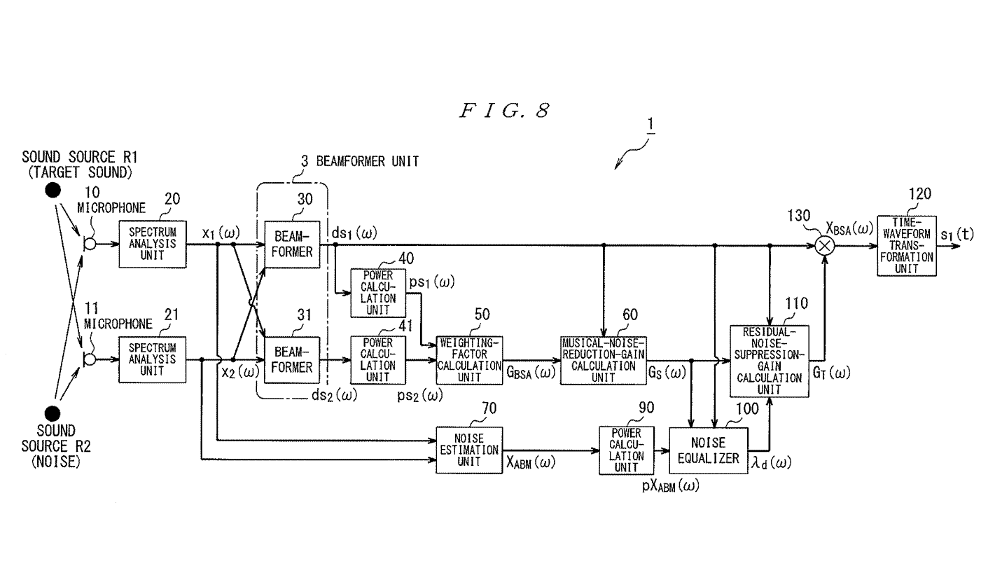

FIG. 7 is a block diagram of the noise equalizer 100. The explanation will be given of an example case in which, as inputs to the noise equalizer 100, an output pX_{ABM}(ω) of the power calculation unit 90, an output G_{S}(ω) of the musical-noise-reduction-gain calculation unit 60, and the output ds₁(ω) of the beamformer 30 are used.

First, a multiplier 101 multiplies ds₁(ω) by G_{S}(ω). A power calculation unit 102 calculates the power of the output by such a multiplier. Smoothing units 103 and 104 perform smoothing process on the output pX_{ABM}(ω) of the power calculation unit 90 and an output pX_{S}(ω) of the power calculation unit 102 in an interval where sounds are determined as noises based on the external VAD value and upon reception of a signal from the control unit 160. The “smoothing process” is a process of averaging data in successive pieces of data in order to reduce the effect of data largely different from other pieces of data. According to this embodiment, the smoothing process is performed using a primary IIR filter, and an output pX′_{ABM}(ω) of the power calculation unit 90 and an output pX′_{S}(ω) of the power calculation unit 102 both having undergone the smoothing process are calculated based on the output pX_{ABM}(ω)) of the power calculation unit 90 and the output pX_{S}(ω) of the power calculation unit 102 in the currently processed frame with reference to the output by the power calculation unit 90 and the output by the power calculation unit 102 having undergone the smoothing process in a past frame. As an example smoothing process, the output pX′_{ABM}(ω) of the power calculation unit 90 and the output pX′_{S}(ω) of the power calculation unit 102 both having undergone the smoothing process are calculated as a following formula (13-1). In order to facilitate understanding for a time series, a processed frame number m is used, and it is presumed that a currently processed frame is m and a processed frame right before is m−1. The process by the smoothing unit 103 may be executed when a threshold comparison unit 105 determines that the control signal from the control unit 160 is smaller than a predetermined threshold.

pX′_{S}(ω,m)=α·pX′_{S}(ω,m−1)+(1−α)·pX_{S}(ω,m) (13-1)

pX′_{ABM}(ω,m)=α·pX′_{ABM}(ω,m−1)+(1−α)·pX_{ABM}(ω,m) (13-2)

An equalizer updating unit 106 calculates an output ratio between pX′_{ABM}(ω) and pX′_{S}(ω). That is, the output by the equalizer updating unit 106 becomes as follow.

$${H}_{EQ} ( ω , m ) = \frac{{pX}_{S}^{′} ( ω , m ) }{{pX}_{ABM}^{′} ( ω , m )} \qquad ( 14 )$$

An equalizer adaptation unit 107 calculates power pλ_{d}(ω) of the estimated noises contained in X_{S}(ω) based on an output H_{EQ}(ω) of the equalizer updating unit 106 and the output pX_{ABM}(ω) of the power calculation unit 90. pλ_{d}(ω) can be calculated based on, for example, a following calculation.

pλ_{d}(ω)=H_{EQ}(ω)·pX_{ABM}(ω) (15)

(Residual-Noise-Suppression-Gain Calculation Unit)

The residual-noise-suppression-gain calculation unit 110 recalculates a gain to be multiplied to ds₁(ω) in order to suppress noise components residual when the gain value G_{S}(ω) is applied to the output ds₁(ω) of the beamformer 30. That is, the residual-noise-suppression-gain calculation unit 110 calculates a residual noise suppression gain G_{T}(ω) that is a gain for appropriately eliminating the noise components contained in X_{S}(ω) based on an estimated value λ_{d}(ω) of the noise components with respect to the value X_{S}(ω) obtained by applying G_{S}(ω) to ds₁(ω). For calculation of the gain, a Wiener filter or an MMSE-STSA technique (see Non-patent Document 1) are widely applied. According to the MMSE-STSA technique, however, it is assumed that noises are in a normal distribution, and non-stationary noises, etc., do not match the assumption of MMSE-STSA in some cases. Hence, according to this embodiment, an estimator that is relatively likely to suppress non-stationary noises is used. However, any techniques are applicable to the estimator.

The residual-noise-suppression-gain calculation unit 110 calculates the gain G_{T}(ω) as follows. First, the residual-noise-suppression-gain calculation unit 110 calculates an instant Pre-SNR (a ratio of clean sound and noises (S/N))) derived based on a post-SNR (S+N)/N).

$$γ ( ω ) = max ( \frac{{\vert {X}_{S} ( ω ) \vert}^{2}}{p {λ}_{d} ( ω )} - 1 , 0 ) \qquad ( 16 )$$

Next, the residual-noise-suppression-gain calculation unit 110 calculates a pre-SNR (a ratio of clean sound and noises (S/N))) through DECISION-DIRECTED APPROACH.

$$ξ ( ω , m ) = \frac{α \cdot {\vert {X}_{S} ( ω , m - 1 ) \vert}^{2}}{p {λ}_{d} ( ω )} + ( 1 - α ) \cdot γ ( ω ) \qquad ( 17 )$$

Subsequently, the residual-noise-suppression-gain calculation unit 110 calculates an optimized gain based on the pre-SNR. β_{P}(ω) in a following formula (18) is a spectral floor value that defines the lower limit value of the gain. By setting this to be a large value, the sound quality deterioration of the target sound can be suppressed but the residual noise quantity increases. Conversely, if setting is made to have a small value, the residual noise quantity decreases but the sound quality deterioration of the target sound increases.

$${G}_{P} ( ω ) = max ( \sqrt{\frac{ξ ( ω , m )}{1 + ξ ( ω , m )}} , {β}_{P} ( ω ) ) \qquad ( 18 )$$

The output value by the residual-noise-suppression-gain calculation unit 110 can be expressed as follow.

$$\begin{matrix}{X}_{P} ( ω ) = {X}_{S} ( ω ) {G}_{P} ( ω ) \\ = {ds}_{{ }_{1}} ( ω ) {G}_{T} ( ω )\end{matrix} \\ where , \\ {G}_{T} ( ω ) = \{ {γ}_{S} ( 1 - {G}_{BSA} ( ω ) ) + 1 \} {G}_{P} ( ω ) \qquad ( 19 )$$

Accordingly, as the gain to be multiplied to the output ds₁(ω) of the beamformer 30, the gain value G_{T}(ω) which reduces the musical noises and which also suppresses the residual noises are recalculated. Moreover, in order to prevent an excessive suppression of the target sound, the value of λ_{d}(ω) can be adjusted in accordance with the external VAD information and the value of the control signal from the control unit 160 of the present invention.

(Gain Multiplication Unit)

The output G_{BSA}(ω) of the weighting-factor calculation unit 50, the output G_{S}(ω) of the musical-noise-reduction-gain calculation unit 60, or the output G_{T}(ω) of the residual-noise-suppression calculation unit 110 is used as an input to a gain multiplication unit 130. The gain multiplication unit 130 outputs the signal X_{BSA}(ω) based on a multiplication result of the output ds₁(ω) of the beamformer 30 by the weighting factor G_{BSA}(ω), the musical noise reducing gain G_{S}(ω), or the residual noise suppression G_{T}(ω). That is, as a value of X_{BSA}(ω), for example, a multiplication value of ds₁(ω) by G_{BSA}(ω) a multiplication value of ds₁(ω) by G_{S}(ω), or a multiplication value of ds₁(ω) by G_{T}(ω) can be used.

In particular, the sound source signal from the target sound source and obtained from the multiplication value of ds₁(ω) by G_{T}(ω) contains extremely little musical noises and noise components.

X_{BSA}(ω)=G_{T}(ω)ds₁(ω) (20)

(Time-Waveform Transformation Unit)

The time-waveform transformation unit 120 transforms the output X_{BSA}(ω) of the gain multiplication unit 130 into a time domain signal.

(Another Configuration of Sound Source Separation System)

FIG. 8 is a diagram showing another illustrative configuration of a sound source separation system according to this embodiment. The difference between this configuration and the configuration of the sound source separation system shown in FIG. 1 is that the noise estimation unit 70 of the sound source separation system in FIG. 1 is realized over a time domain, but it is realized over a frequency domain according to the sound source separation system shown in FIG. 8. The other configurations are consistent with those of the sound source separation system shown in FIG. 1. According to this configuration, the spectrum analyze unit 80 becomes unnecessary.

### Second Embodiment

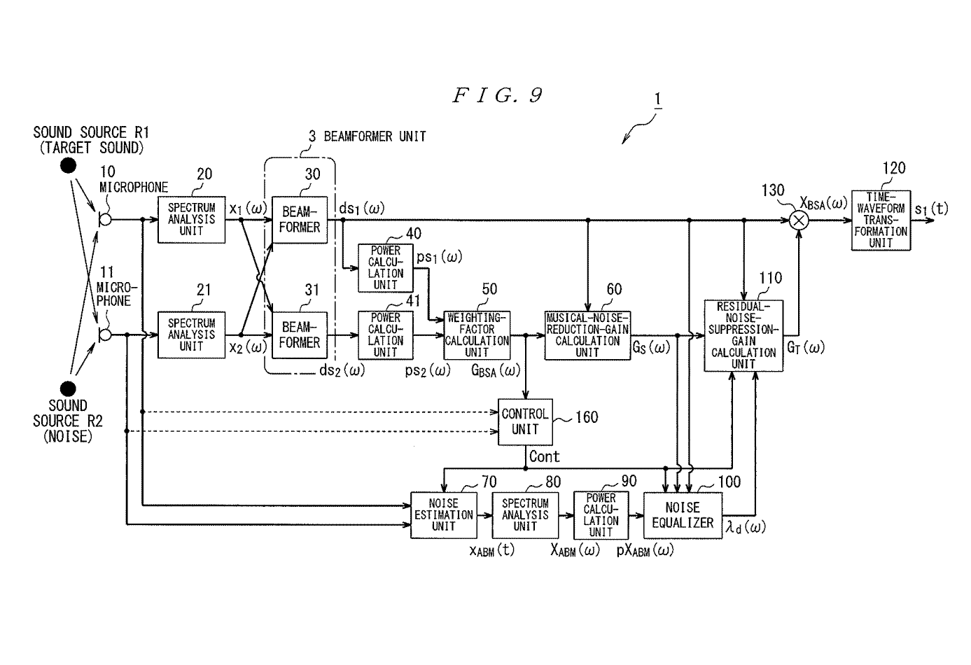

FIG. 9 is a diagram showing a basic configuration of a sound source separation system according to a second embodiment of the present invention. The feature of the sound source separation system of this embodiment is to include a control unit 160. The control unit 160 controls respective internal parameters of the noise estimation unit 70, the noise equalizer 100, and the residual-noise-suppression-gain calculation unit 110 based on the weighting factor G_{BSA}(ω) across the entire frequency band. Example internal parameters are a step size of the adaptive filter, a spectrum floor value β of the weighting factor G_{BSA}(ω), and a noise quantity of estimated noises.

More specifically, the control unit 160 executes following processes. For example, an average value of the weighting factor G_{BSA}(ω) across the entire frequency band is calculated. If such an average value is large, it is possible to make a determination that a sound presence probability is high, so that the control unit 160 compares the calculated average and a predetermined threshold, and controls other blocks based on the comparison result.

Alternatively, for example, the control unit 160 calculates, from 0 to 1.0, the histogram of the weighting factor G_{BSA}(ω) calculated by the weighting-factor calculation unit 50 for each 0.1. When the value of G_{BSA}(ω) is large, the probability that sound is present is high, and when the value of G_{BSA}(ω) is small, the probability that sound is present is low. Accordingly, a weighting table indicating such a tendency is prepared in advance. Next, the calculated histogram is multiplied by such a weighting table to calculate an average value, the average value is compared with a threshold, and the other blocks are controlled based on the comparison result.

Moreover, for example, the control unit 160 calculates, from 0 to 1.0, the histogram of the weighting factor G_{BSA}(ω) for each 0.1, counts the number of histograms distributed within a range from 0.7 to 1.0 for example, compares such a number with a threshold, and controls the other blocks based on the comparison result.

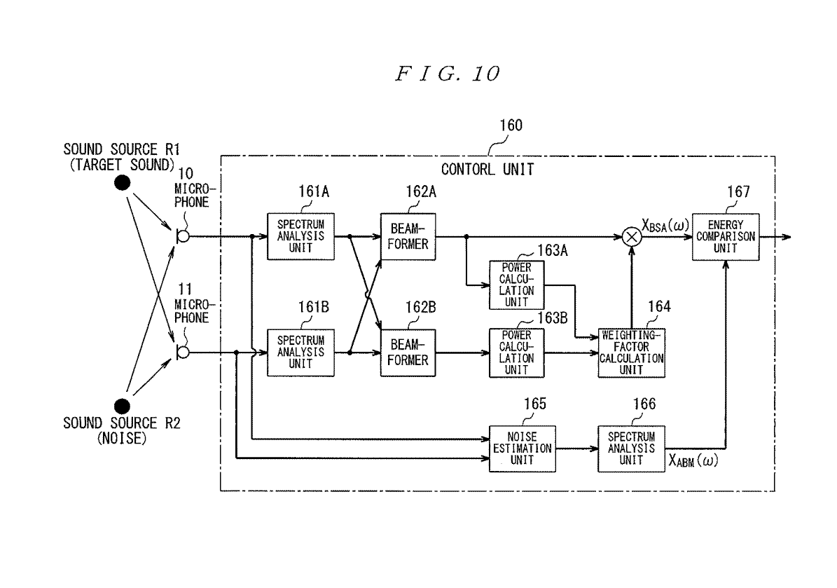

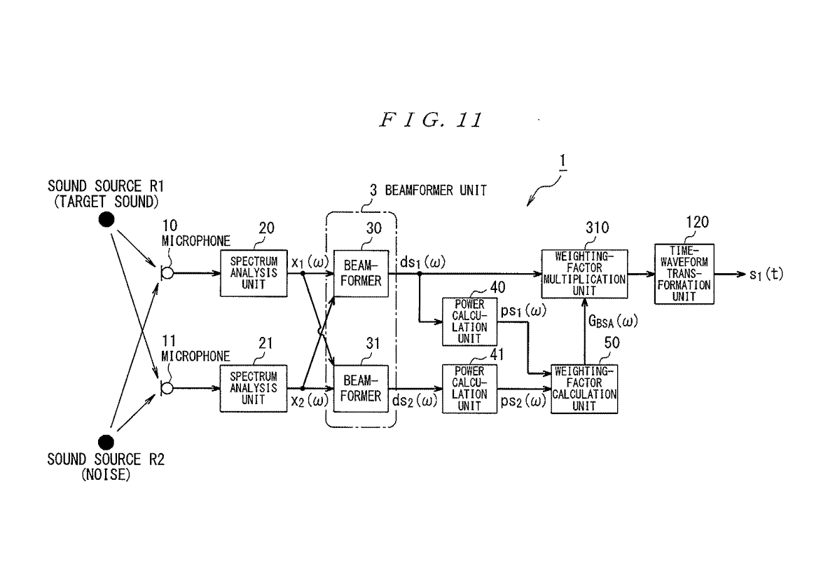

Furthermore, the control unit 160 may receive an output signal from at least either one of the two microphones (microphones 10 and 11). FIG. 10 is a block diagram showing the control unit 160 in this case. The basic idea for the process by the control unit 160 is that an energy comparison unit 167 compares the power spectrum density of the signal X_{BSA}(ω) obtained by multiplying ds₁(ω) by G_{BSA}(ω) with the power spectrum density of the output X_{ABM}(ω) of the process by the noise estimation unit 165 and the spectrum analyze unit 166.

More specifically, when it is presumed that X_{BSA}(ω)′ and X_{ABM}(ω)′ are obtained by obtaining logarithms for respective power spectrum densities of X_{BSA}(ω) and X_{ABM}(ω), and smoothing respective logarithms, the control unit 160 calculates an estimated SNR D(ω) of the target sound as follow.

D(ω)=max(X_{BSA}′−X_{ABM}′,0) (25)

Next, like the above-explained process by the noise estimation unit 70 and the spectrum analyze unit 80, a stationary (noise) component D_{N}(ω) is detected from D(ω), and D_{N}(ω) is subtracted from D(ω). Accordingly, a non-stationary noise component D_{S}(ω) contained in D(ω) can be detected.

D_{S}(ω)=D(ω)−D_{N}(ω) (26)

Eventually, D_{S}(ω) and a predetermined threshold are compared with each other, and the other control blocks are controlled based on the comparison result.

### Third Embodiment

(First Configuration)

FIG. 11 shows an illustrative basic configuration of a sound source separation system according to a third embodiment of the present invention.

A sound source separation device 1 of the sound source separation system shown in FIG. 11 includes a spectrum analyze units 20 and 21, beamformers 30 and 31, power calculation units 40 and 41, a weighting-factor calculation unit 50, a weighting-factor multiplication unit 310, and a time-waveform transformation unit 120. The configuration other than the weighting-factor multiplication unit 310 is consistent with the configurations of the above-explained other embodiments.

The weighting-factor multiplication unit 310 multiplies a signal ds₁(ω) obtained by the beamformer 30 by a weighting factor calculated by the weighting-factor calculation unit 50.

(Second Configuration)

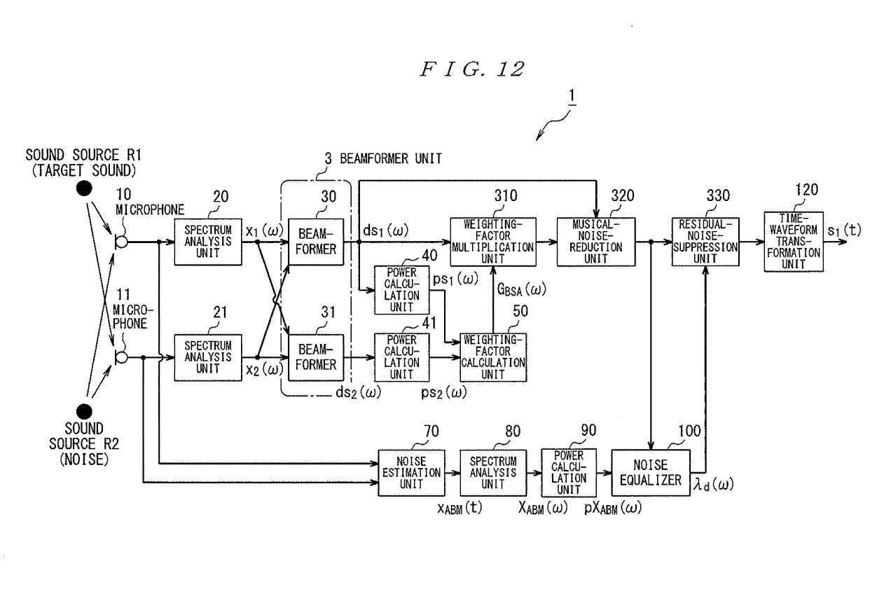

FIG. 12 is a diagram showing another illustrative basic configuration of a sound source separation system according to the third embodiment of the present invention.

A sound source separation device 1 of the sound source separation system shown in FIG. 12 includes spectrum analyze units 20 and 21, beamformers 30 and 31, power calculation units 40 and 41, a weighting-factor calculation unit 50, a weighting-factor multiplication unit 310, a musical-noise reduction unit 320, a residual-noise suppression unit 330, a noise estimation unit 70, a spectrum analysis unit 80, a power calculation unit 90, a noise equalizer 100, and a time-waveform transformation unit 120. The configuration other than the weighting-factor multiplication unit 310, the musical-noise reduction unit 320, and the residual-noise suppression unit 330 is consistent with the configurations of the above-explained other embodiments.

The musical-noise reduction unit 320 outputs a result of adding an output result by the weighting-factor multiplication unit 310 and a signal obtained from the beamformer 30 at a predetermined ratio.

The residual-noise suppression unit 330 suppresses residual noises contained in an output result by the musical-noise reduction unit 320 based on the output result by the musical-noise reduction unit 320 and an output result by the noise equalizer 100.

Moreover, according to the configuration shown in FIG. 12, the noise equalizer 100 calculates noise components contained in the output result by the musical-noise reduction unit 320 based on the output result by the musical-noise reduction unit and the noise components calculated by the noise estimation unit 70.

A signal X_{S}(ω) obtained by adding, at a predetermined ratio, a signal X_{BSA}(ω) obtained by multiplying the output ds₁(ω) of the beamformer 30 by a weighting factor G_{BSA}(ω) and the output ds₁(ω) of the beamformer 30 may contain non-stationary noises depending on a noise environment. Hence, in order to enable estimation of non-stationary noises, the noise estimation unit 70 and the noise equalizer 100 to be discussed later are introduced.

According to the above-explained configuration, the sound source separation device 1 of FIG. 12 separates, from mixed sounds, a sound source signal from the target sound source based on the output result by the residual-noise suppression unit 330.

That is, the sound source separation device 1 of FIG. 12 differs from the sound source separation devices 1 of the first embodiment and the second embodiment that no musical-noise-reduction gain G_{S}(ω) and residual-noise suppression-gain G_{T}(ω) are calculated. According to the configuration shown in FIG. 12, also, the same advantage as that of the sound source separation device 1 of the first embodiment can be obtained.

(Third Configuration)

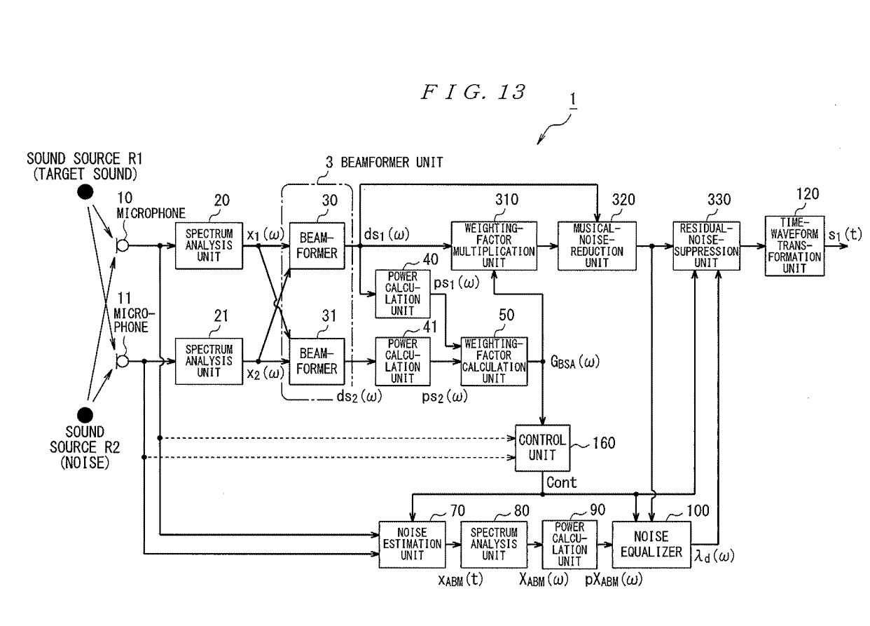

Moreover, FIG. 13 shows the other illustrative basic configuration of a sound source separation system according to the third embodiment of the present invention. A sound source separation device 1 shown in FIG. 13 includes a control unit 160 in addition to the configuration of the sound source separation device 1 of FIG. 12. The control unit 160 has the same function as that of the second embodiment explained above.

### Fourth Embodiment

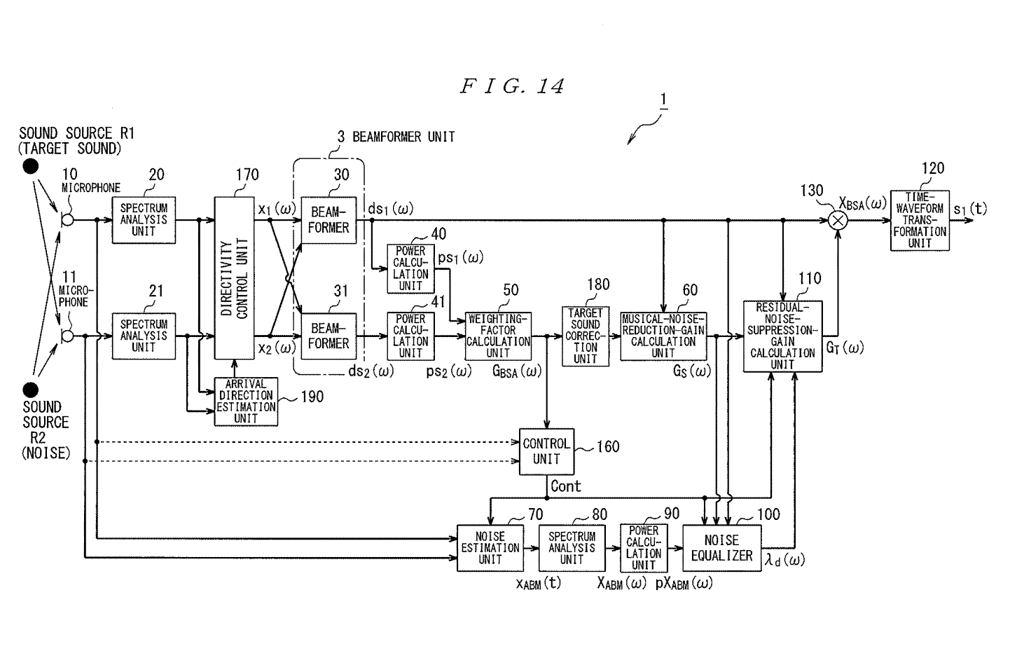

FIG. 14 is a diagram showing a basic configuration of a sound source separation system according to a fourth embodiment of the present invention. The feature of the sound source separation system of this embodiment is to include a directivity control unit 170, a target sound compensation unit 180, and an arrival direction estimation unit 190.

The directivity control unit 170 performs a delay operation on either one of the microphone outputs subjected to frequency analysis by the spectrum analysis units 20 and 21, respectively, so that two sound sources R1 and R2 to be separated are virtually as symmetrical as possible relative to the separation surface based on a target sound position estimated by the arrival direction estimation unit 190. That is, the separation surface is virtually rotated, and an optimized value for the rotation angle at this time is calculated based on a frequency band.

When a beamformer unit 3 performs filtering after the directivity is narrowed down by the directivity control unit 170, the frequency characteristics of the target sound may be slightly distorted. Moreover, when a delay amount is given to the input signal to the beamformer unit 3, the output gain becomes small. Hence, the target sound compensation unit 180 corrects the frequency characteristics of the target sound.

(Directivity Control Unit)

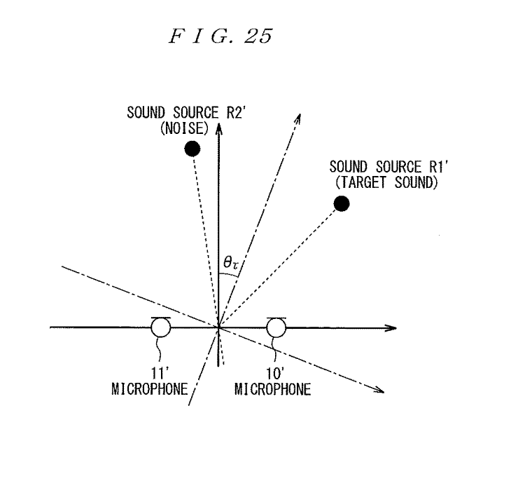

FIG. 25 shows a condition in which two sound sources R′1 (target sound) and R′2 ‘(noises) are symmetrical with respect to a separation surface rotated by θτ relative to the original separation surface intersecting a line interconnecting the microphones. As is disclosed in Patent Document 1, when a certain delay amount τ_{d} is given to a signal obtained by the one microphone, an equivalent condition to the condition shown in FIG. 25 can be realized. That is, in order to operate a phase difference between the microphones and to adjust the directivity characteristics, in the above-explained formula (1), a phase rotator D(ω) is multiplied. In a following formula, W₁(ω)=W₁(ω, θ₁, θ₂), X(ω)=X(ω, θ₁, θ₂).

ds₁(ω)=W₁^{H}(ω)D(ω)X(ω) (27-1)

D(ω)=exp(jωτ_{d}) (27-2)

The delay amount τ_{d} can be calculated as follow.

$${τ}_{d} = \frac{d sin {θ}_{τ}}{c} \qquad ( 28 )$$

Note that d is a distance between the microphones [m] and c is a sound velocity [m/s].

When, however, an array process is performed based on phase information, it is necessary to satisfy a spatial sampling theorem expressed by a following formula.

$$d < \frac{c π}{ω} \qquad ( 29 )$$

A maximum value τ₀ allowable to satisfy this theorem is as follow.

$$d + {τ}_{0} \cdot c = \frac{c π}{ω} ⇔ {τ}_{0} = \frac{π}{ω} - \frac{d}{c} \qquad ( 30 )$$

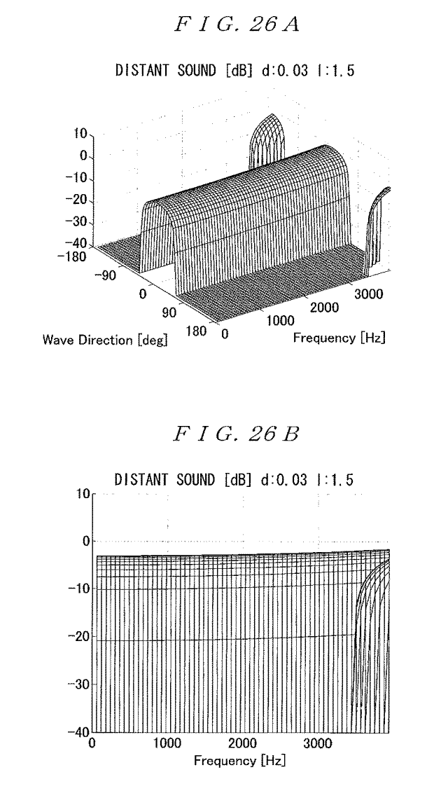

The larger each frequency ω is, the smaller the allowable delay amount τ₀ becomes. According to the sound source separation device of Patent Document 1, however, since the delay amount given from the formula (27-2) is constant, there is a case in which the formula (29) is not satisfied at a high range of a frequency domain. As a result, as shown in FIG. 26, sound of high-range components at an opposite zone deriving from a direction largely different from the desired sound source separation surface is inevitably output.

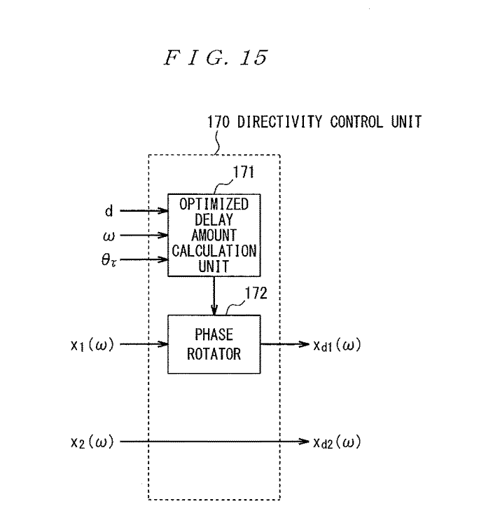

Hence, according to the sound source separation device of this embodiment, as shown in FIG. 15, an optimized delay amount calculation unit 171 is provided in the directivity control unit 170 to calculate an optimized delay amount satisfying the spatial sampling theorem for each frequency band, not to apply a constant delay to the rotational angle θτ at the time of the virtual rotation of the separation surface, thereby addressing the above-explained technical issue.

The directivity control unit 170 causes the optimized delay amount calculation unit 171 to determine whether or not the spatial sampling theorem is satisfied for each frequency when the delay amount derived from the formula (28) based on θτ is given. When the spatial sampling theorem is satisfied, the delay amount τ_{d} corresponding to θτ is applied to the phase rotator 172, and when no spatial sampling theorem is satisfied, the delay amount τ₀ is applied to the phase rotator 172.

$${ds}_{1} ( ω ) = {W}_{1}^{H} ( ω ) D ( ω ) X ( ω ) \\ where , \\ D ( ω ) = \{ \begin{matrix}diag ( exp [ j {ωτ}_{d} ] , 1 ) & if {θ}_{τ} < {sin}^{- 1} ( c π / d ω - 1 ) \\ diag ( exp [ j {ωτ}_{0} ] , 1 ) & else\end{matrix} \qquad ( 31 )$$

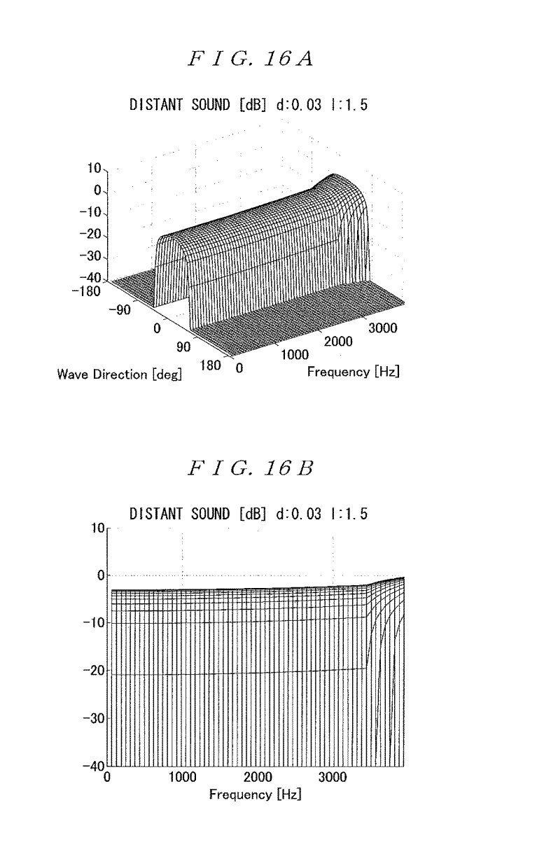

FIG. 16 is a diagram showing directivity characteristics of the sound source separation device 1 of this embodiment. As shown in FIG. 16, by applying the delay amount of the formula (31), the technical issue such that sound of high-frequency components at the opposite zone arrived from a direction largely different from the desired sound source separation surface is output can be addressed.

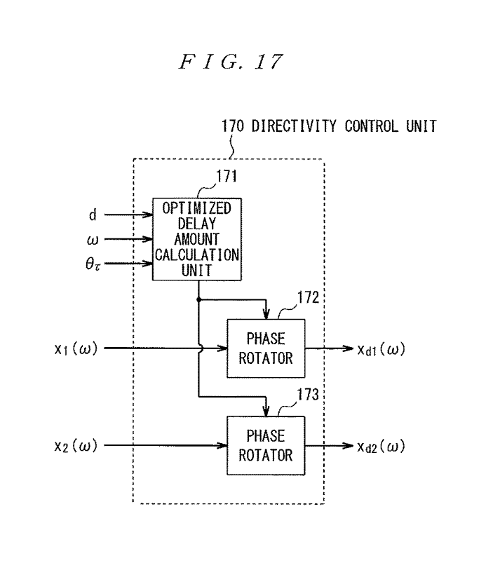

Moreover, FIG. 17 is a diagram showing another configuration of the directivity control unit 170. In this case, the delay amount calculated by the optimized delay amount calculation unit 171 based on the formula (31) is not applied to the one microphone input, but respective half delays may be given to both microphone inputs by phase rotators 172 and 173 to realize the equivalent delay operation. That is, a delay amount τ_{d}/2 (or τ₀/2) is given to a signal obtained through the one microphone, and a delay −τ_{d}/2 (or −τ₀/2) is given to a signal obtained through another microphone, thereby accomplishing a difference in delay of τ_{d} (or τ₀), not by giving the delay τ_{d} (or τ₀) to the signal obtained through the one microphone.

(Target Sound Compensation Unit)

Another technical issue is that when the beamformers 30 and 31 perform respective BSA processes after the directivity is narrowed down by the directivity control unit 170, the frequency characteristics of the target sound is slightly distorted. Also, through the process of the formula (31), the output gain becomes small. Hence, the target sound compensation unit 180 that corrects the frequency characteristics of the target sound output is provided to perform frequency equalizing. That is, the place of the target sound is substantially fixed, and thus the estimated target sound position is corrected. According to this embodiment, a physical model that models, in a simplified manner, a transfer function which represents a propagation time from any given sound source to each microphone and an attenuation level is utilized. In this example, the transfer function of the microphone 10 is taken as a reference value, and the transfer function of the microphone 11 is expressed as a relative value to the microphone 10. At this time, a propagation model Xₘ(ω)=[Xₘ₁(ω), Xₘ₂(ω)] of sound reaching to each microphone from a target sound position can be expressed as follow. Note that γₛ is a distance between the microphone 10 and the target sound, and θ_{S} is a direction of the target sound.

Xₘ₁(ω)=1

Xₘ₂(ω)=u⁻¹·exp{−jωτₘd(u−1)/c} (32)

where, u=1+(2/rₘ)cos θₘ+(1/rₘ²)

By utilizing this physical model, it becomes possible to simulate in advance how a voice uttered from an estimated target sound position is input into each microphone, and the distortion level to the target sound can be calculated in a simplified manner. The weighting factor to the above-explained propagation model is G_{BSA}(ω|Xₘ(ω)), and the inverse number thereof is retained as a equalizer by the target sound correcting unit 180, thereby enabling the compensation of frequency distortion of the target sound. Hence, the equalizer can be obtained as follow.

$${E}_{m} ( ω ) = \frac{1}{{G}_{BSA} ( ω \vert {X}_{m} ( ω ) )} \qquad ( 33 )$$

Accordingly, the weighting factor G_{BSA}(ω) calculated by the weighting-factor calculation unit 50 is corrected to G_{BSA}′(ω) by the target sound compensation unit 180 and expressed as a following formula.

G_{BSA}′(ω)=Eₘ(ω)G_{BSA}(ω) (34)

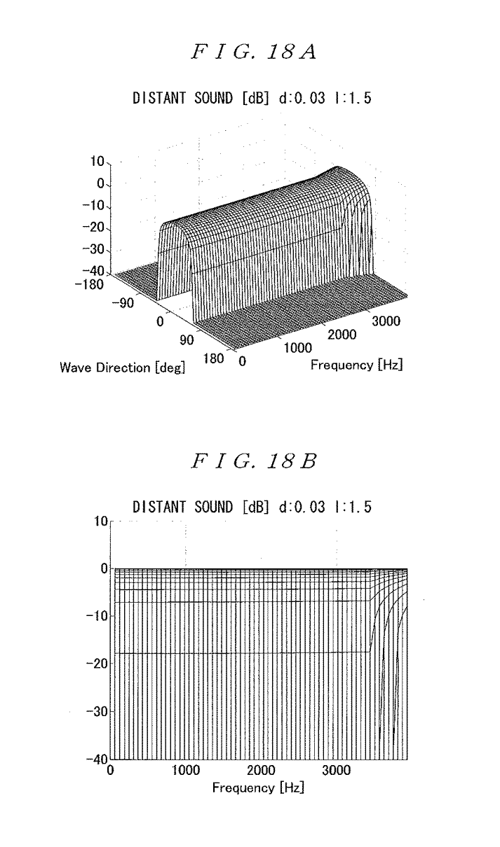

FIG. 18 shows the directivity characteristics of the sound source separation device 1 having the equalizer of the target sound compensation unit 180 designed in such a way that θ_{S} is 0 degree, and γₛ is 1.5 [m]. It can be confirmed from FIG. 18 that an output signal has no frequency distortion with respect to sound arrived from a sound source in the direction of 0 degree.

The musical-noise-reduction-gain calculation unit 60 takes the corrected weighting factor G_{BSA}′(ω) as an input. That is, G_{BSA}(ω) in the formula (7), etc., is replaced with G_{BSA}′(ω).

Moreover, at least either one of the signals obtained through the microphones 10 and 11 may be input to the control unit 160.

(Flow of Process by Sound Source Separation System)

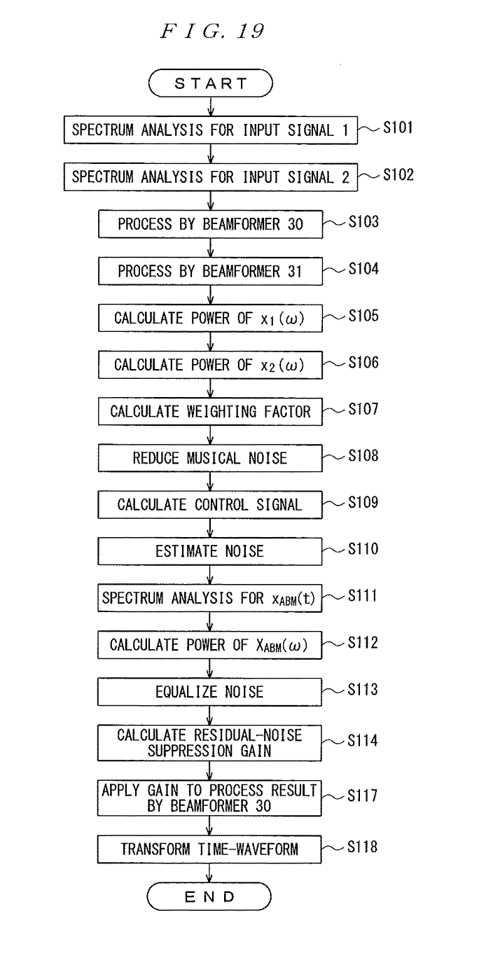

FIG. 19 is a flowchart showing an example process executed by the sound source separation system.

The spectrum analysis units 20 and 21 perform frequency analysis on input signal 1 and input signal 2, respectively, obtained through the microphones 10 and 20 (steps S101 and S102). At this stage, the arrival direction estimation unit 190 may estimate a position of the target sound, and the directivity control unit 170 may calculate the optimized delay amount based on the estimated positions of the sound sources R1 and R2, and the input signal 1 may be multiplied by a phase rotator in accordance with the optimized delay amount.

Next, the beamformers 30 and 31 perform filtering on respective signals x₁(ω) and x₂(ω) having undergone the frequency analysis in the steps S101 and S102 (steps S103 and S104). The power calculation units 40 and 41 calculate respective powers of the outputs through the filtering (steps S105 and S106).

The weighting-factor calculation unit 50 calculates a separation gain value G_{BSA}(ω) based on the calculation results of the steps S105 and S106 (step S107). At this stage, the target sound compensation unit 180 may recalculate the weighting factor value G_{BSA}(ω) to correct the frequency characteristics of the target sound.

Next, the musical-noise-reduction-gain calculation unit 60 calculates a gain value G_{S}(ω) that reduces the musical noises (step S108). Moreover, the control unit 160 calculates respective control signals for controlling the noise estimation unit 70, the noise equalizer 100, and the residual-noise-suppression-gain calculation unit 110 based on the weighting factor G_{BSA}(ω) calculated in the step S107 (step S109).

Next, the noise estimation unit 70 executes estimation of noises (step S110). The spectrum analysis unit 80 performs frequency analysis on a result X_{ABM}(t) of the noise estimation in the step S110 (step S111), and the power calculation unit 90 calculates power for each frequency bin (step S112). Moreover, the noise equalizer 100 corrects the power of the estimated noises calculated in the step S112.

Subsequently, the residual-noise-suppression-gain calculation unit 110 calculates a gain G_{T}(ω) for eliminating the noise components with respect to a value obtained by applying the gain value G_{S}(ω) calculated in the step S108 to an output value ds₁(ω) of the beamformer 30 processed in the step S103 (step S114). Calculation of the gain G_{T}(ω) is carried out based on an estimated value λ_{d}(ω) of the noise components having undergone power correction in the step S112.

The gain multiplication unit 130 multiplies the process result by the beamformer 30 in the step S103 by the gain calculated in the step S114 (step S117).

Eventually, the time-waveform transformation unit 120 transforms the multiplication result (the target sound) in the step S117 into a time domain signal (step S118).

Moreover, as explained in the third embodiment, noises may be eliminated from the output signal by the beamformer 30 by the musical-noise reduction unit 320 and the residual-noise suppression unit 330 without through the calculation of the gains in the step S108 and the step S114.

Respective processes shown in the flowchart of FIG. 19 can be roughly categorized into three processes. That is, such three processes are an output process from the beamformer 30 (steps S101 to S103), a gain calculation process (steps S101 to S108 and step S114), and a noise estimation process (steps S110 to S113).

Regarding the gain calculation process and the noise estimation process, after the weighting factor is calculated through the steps S101 to S107 of the gain calculation process, the process in the step S108 is executed, while at the same time, the process in the step S109 and the noise estimation process (steps S110 to S113) are executed, and then the gain to be multiplied by the output by the beamformer 30 is set in the step S114.

(Flow of Process by Noise Estimation Unit)

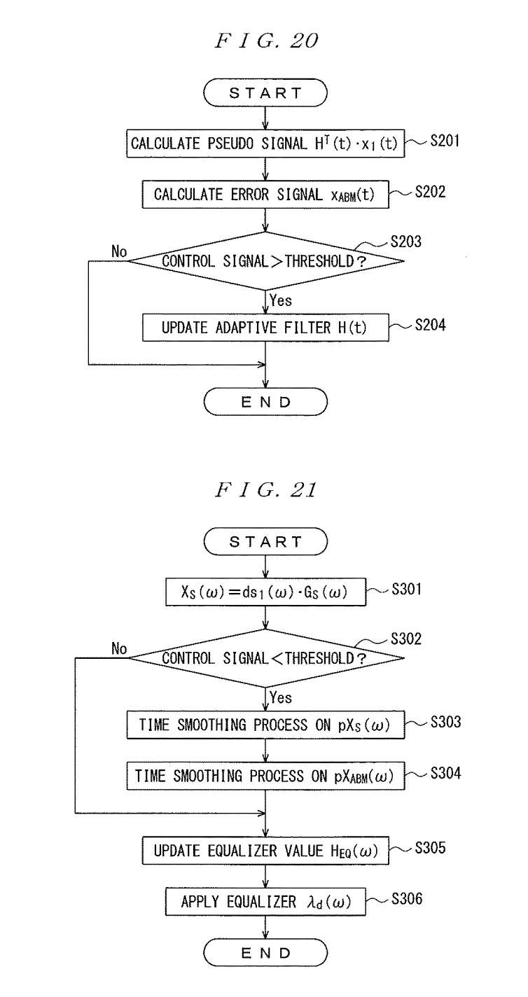

FIG. 20 is a flowchart showing the detail of the process in the step S110 shown in FIG. 19. First, a pseudo signal H^{T}(t)·x₁(t) similar to the signal component from the sound source R1 is calculated (step S201). Next, the subtractor 72 shown in FIG. 6 subtracts the pseudo signal calculated in the step S201 from a signal x₂(t) obtained through the microphone 11, and thus an error signal x_{ABM}(t) is calculated which is the output by the noise estimation unit 70 (step S202).

Thereafter, when the control signal from the control unit 160 is larger than the predetermined threshold (step S203), the adaptive filter 71 updates the adaptive filtering coefficient H(t) (step S204).

(Flow of Process by Noise Equalizer)

FIG. 21 is a flowchart showing the detail of the process in the step S113 shown in FIG. 19. First, the output ds₁(ω) by the beamformer 30 is multiplied by the gain G_{S}(ω) output by the musical-noise-reduction-gain calculation unit 60, and an output X_{S}(ω) is obtained (step S301).

When the control signal from the control unit 160 is smaller than the predetermined threshold (step S302), the smoothing unit 103 shown in FIG. 7 executes a time smoothing process on an output pX_{S}(ω) by the power calculation unit 102. Moreover, the smoothing unit 104 executes a time smoothing process on an output pX_{ABM}(ω) by the power calculation unit 90 (steps S303, S304).

The equalizer updating unit 106 calculates a ratio H_{EQ}(ω) of the process results in the step S303 and the step S304, and the equalizer value is updated to H_{EQ}(ω) (step S305). Eventually, the equalizer adaptation unit 107 calculates the estimated noises λ_{d}(ω) contained in X_{S}(ω) (step S306).

(Flow of Process by Residual-Noise-Suppression-Gain Calculation Unit 110)

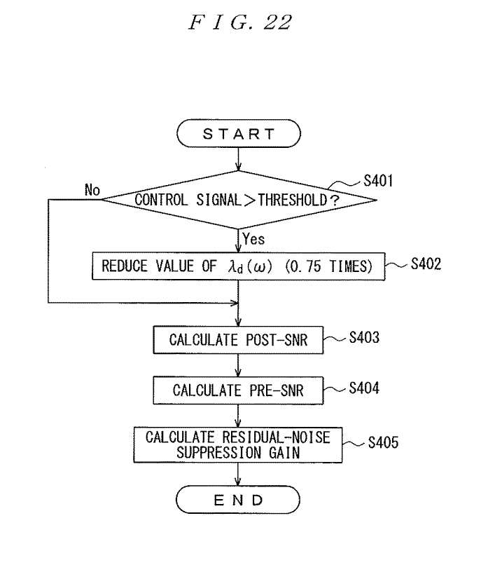

FIG. 22 is a flowchart showing the detail of the process in the step S114 in FIG. 19. When the control signal from the control unit 160 is larger than the predetermined threshold (step S401), a process of reducing the value of λ_{d}(ω) which is the output by the noise equalizer 100 and which is also an estimated value of the noise components to be, for example, 0.75 times (step S402). Next, a posteriori-SNR is calculated (step S403). Moreover, a priori-SNR is also calculated (step S404). Eventually, the residual-noise suppression gain G_{T}(ω) is calculated (step S405).

### Other Embodiments

In the calculation of the gain value G_{BSA}(ω) by the weighting-factor calculation unit 50, the weighting factor may be calculated using a predetermined bias value γ(ω). For example, the predetermined bias value may be added to the denominator of the gain value G_{BSA}(ω), and a new gain value may be calculated. It can be expected that addition of the bias value improves, in particular, the low-frequency SNR when the gain characteristics of the microphones are consistent with each other and a target sound is present near the microphone like the cases of a headset and a handset.

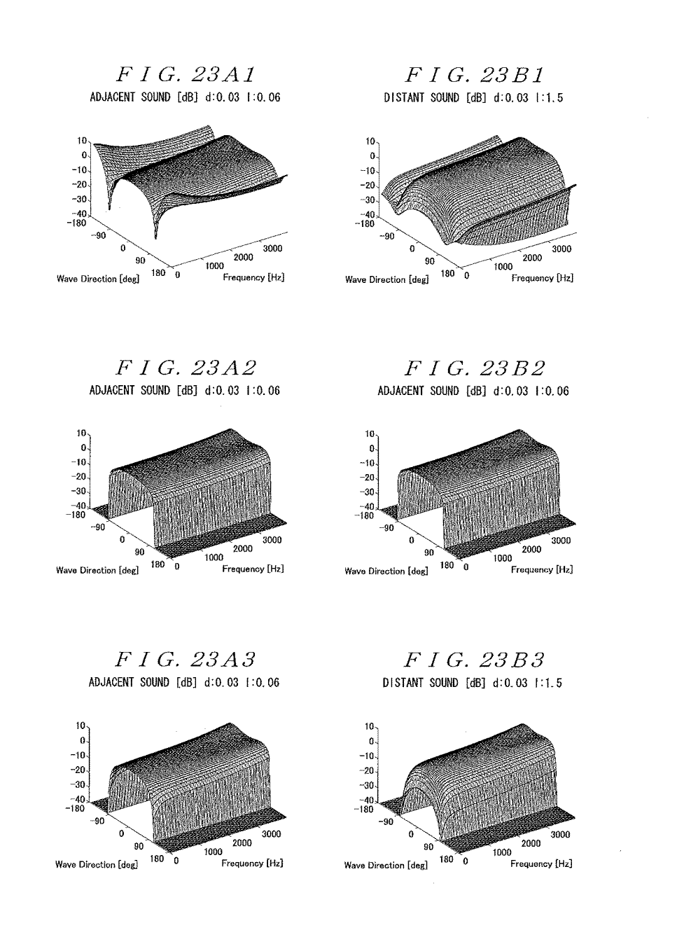

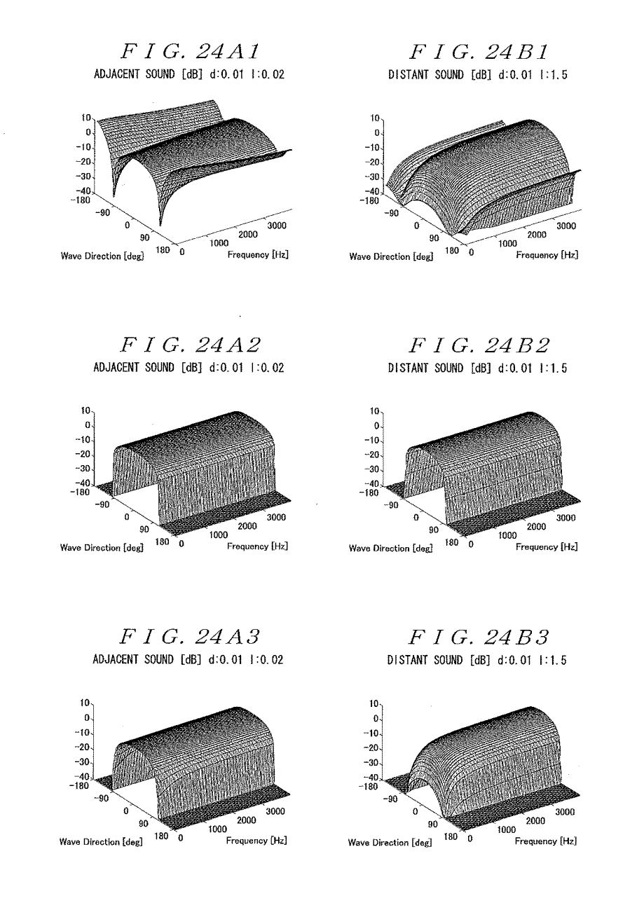

FIGS. 23 and 24 are diagrams showing a graph for comparing the output value by the beamformer 30 between near-field sound and far-field sound. In FIGS. 23 and 24, A1 to A3 are graphs showing an output value for near-field sound, and B1 to B3 are graphs showing an output value for far-field sound. In FIG. 23, a pitch between the microphone 10 and the microphone 11 was 0.03 m, and the distances between the microphone 10 and the sound sources R1 and R2 were 0.06 m (meter) and 1.5 m, respectively. Moreover, in FIG. 24, a pitch between the microphone 10 and the microphone 11 was 0.01 m and the distances between the microphone 10 and the sound sources R1 and R2 were 0.02 m (meter) and 1.5 m, respectively.

For example, FIG. 23A1 is a graph showing a value of an output value ds₁(ω) (=|X(ω)W₁(ω)|²) by the beamformer 30 in accordance with near-field sound, and FIG. 23B1 is a graph showing a value of ds₁(ω) in accordance with far-field sound. In this example, the target sound correcting unit 180 was designed in such a way that the near-field sound was the target sound, and in the case of the far-field sound, the target sound correcting unit 180 affected the value of ps₁(ω) so as to be small at a low frequency. Moreover, when the value of ds₁(ω) is small (i.e., when the value of ps₁(ω) is small), the effect of γ(ω) becomes large. That is, since the item of the denominator becomes large relative to the numerator, G_{BSA}(ω) becomes further small. Hence, the low frequency of the far-filed sound is suppressed.

$${G}_{BSA} ( ω ) = \sqrt{\frac{max ( {ps}_{1} ( ω ) - {ps}_{2} ( ω ) , 0 )}{{ps}_{1} ( ω ) + γ ( ω )}} \qquad ( 35 )$$

Moreover, according to the configuration shown in FIG. 7, G_{BSA}(ω) obtained from the formula (35) is applied to the output value ds₁(ω) by the beamformer 30, and the multiplication result X_{BSA}(ω) of ds₁(ω) by G_{BSA}(ω) is calculated as follow. In the following formula, as an example case, the sound source separation device 1 employs the configuration shown in FIG. 7.

X_{BSA}(ω)=G_{BSA}(ω)ds₁(ω) (36)

As explained above, in FIGS. 23 and 24, A1 and B1 are graphs showing the output ds₁(ω) by the beamformer 30. Moreover, A2 and B2 in respective figures are graphs showing the output X_{BSA}(ω) when no γ(ω) is inserted in the denominator of the formula (35). Furthermore, A3 and B3 of respective figures are graphs showing the output X_{BSA}(ω) when γ(ω) is inserted in the denominator of the formula (35). It becomes clear from respective figures that the low frequency of the far-field sound is suppressed. That is, an effect is expectable for road noises, etc., present mainly in the low frequency.

In the above explanation, the beamformer 30 configures a first beamformer processing unit. Moreover, the beamformer 31 configures a second beamformer processing unit. Furthermore, the gain multiplication unit 130 configures a sound source separation unit.

### INDUSTRIAL APPLICABILITY

The present invention is applicable to all industrial fields that need precise separation of a sound source, such as a voice recognition device, a car navigation, a sound collector, a recording device, and a control for a device through a voice command.

### REFERENCE SIGNS LIST

1 Sound source separation device
3 Beamformer unit
10, 11 Microphone
20, 21 Spectrum analysis unit
30, 31 Beamformer
40, 41 Power calculation unit
50 Weighting-factor calculation unit
60 Musical-noise-reduction-gain calculation unit
70 Noise estimation unit
71 Adaptive filter
72 Subtractor
73 Delay device
74 Threshold comparison unit
80 Spectrum analysis unit
90 Power calculation unit
100 Noise equalizer
101 Multiplier
102 Power calculation unit
103, 104 Smoothing unit
105 Threshold comparison unit
106 Equalizer updating unit
107 Equalizer adaptation unit
110 Residual-noise-suppression-gain calculation unit
120 Time-waveform transformation unit
130 Gain multiplication unit
160 Control Unit
161A, 161B Spectrum analysis unit
162A, 162B Beamformer
163A, 163B Power calculation unit
164 Weighting-factor calculation unit
165 Noise estimation unit
166 Spectrum analysis unit
167 Energy comparison unit
170 Directivity control unit
171 Optimized delay amount calculation unit
172, 173 Phase rotator
180 Target sound correction unit
190 Arrival direction estimation unit
310 Weighting-factor multiplication unit
320 Musical-noise reduction unit
330 Residual-noise suppression unit

1. A sound source separation device that separates, from mixed sounds containing mixed sound source signals output by a plurality of sound sources, a sound source signal from a target sound source, the sound source separation device comprising:
a first beamformer processing unit that performs, in a frequency domain using respective first coefficients different from each other, a product-sum operation on respective output signals by a microphone pair comprising two microphones into which the mixed sounds are input to attenuate a sound source signal arrived from a region opposite to a region including a direction of the target sound source with a plane intersecting with a line interconnecting the two microphones being as a boundary;
a second beamformer processing unit which multiplies respective output signals by the microphone pair by a second coefficient in a relationship of complex conjugate with the first coefficients different from each other in the frequency domain, and which performs a product-sum operation on an obtained result in the frequency domain to attenuate a sound source signal arrived from the region including the direction of the target sound source with the plane being as the boundary;
a power calculation unit which calculates first spectrum information having a power value for each frequency from a signal obtained through the first beamformer processing unit, and which further calculates second spectrum information having a power value for each frequency from a signal obtained through the second beamformer processing unit;
a weighting-factor calculation unit that calculates, in accordance with a difference in the power values for each frequency between the first spectrum information and the second spectrum information, a weighting factor for each frequency to be multiplied by the signal obtained through the first beamformer processing unit; and
a sound source separation unit that separates, from the mixed sounds, the sound source signal from the target sound source based on a multiplication result of the signal obtained through the first beamformer processing unit by the weighting factor calculated by the weighting-factor calculation unit.

2. The sound source separation device according to claim 1, further comprising a weighting-factor multiplication unit that multiplies the signal obtained through the first beamformer processing unit by the weighting factor calculated by the weighting-factor calculation unit,
wherein the sound source separation unit separates, from the mixed sounds, the sound source signal from the target sound source based on a result of adding an output result by the weighting-factor multiplication unit and the signal obtained through the first beamformer processing unit at a predetermined ratio.

3. The sound source separation device according to claim 2, comprising:
a musical-noise reduction unit that outputs a result of adding the output result by the weighting-factor multiplication unit and the signal obtained through the first beamformer processing unit at the predetermined ratio;
a noise estimation unit which applies an adaptive filter having a variable filter coefficient to an output signal from the microphone near the target sound source between the microphone pair to calculate a pseudo signal similar to an output signal by the microphone distant from the target sound source between the microphone pair, and which calculates a noise component based on a difference between the output signal by the microphone distant from the target sound and the pseudo signal;
a noise equalizer that calculates a noise component contained in an output result by the musical-noise reduction unit based on the output result by the musical-noise reduction unit and the noise component calculated by the noise estimation unit; and
a residual-noise suppression unit that suppresses a residual noise contained in the output result by the musical-noise reduction unit based on the output result by the musical-noise reduction unit and an output result by the noise equalizer,
wherein the sound source separation unit separates, from the mixed sounds, the sound source signal from the target sound source based on an output result by the residual-noise suppression unit.

4. The sound source separation device according to claim 3, comprising a control unit that controls at least one of the noise estimation unit, the noise equalizer unit, and the residual-noise suppression unit based on the weighting factor for each frequency.

5. The sound source separation device according to claim 1, comprising a musical-noise-reduction-gain calculation unit that calculates a gain for adding a multiplication result obtained by multiplying the sound source signal obtained through the first beamformer processing unit by the weighting factor and the sound source signal obtained through the first beamformer processing at a predetermined ratio,
wherein the sound source separation unit separates, from the mixed sounds, the sound source signal from the target sound source based on a multiplication result of the sound source signal obtained through the first beamformer processing unit by the gain calculated by the musical-noise-reduction-gain calculation unit.

6. The sound source separation device according to claim 5, comprising:
a noise estimation unit which applies an adaptive filter having a variable filter coefficient to an output signal from the microphone near the target sound source between the microphone pair to calculate a pseudo signal similar to an output signal by the microphone distant from the target sound source between the microphone pair, and which calculates a noise component based on a difference between the output signal by the microphone distant from the target sound and the pseudo signal;
a noise equalizer unit that calculates a noise component contained in a multiplication result of multiplying the sound source signal obtained through the first beamformer processing unit by the gain calculated by the musical-noise-reduction-gain calculation unit based on the multiplication result of multiplying the sound source signal obtained through the first beamformer processing unit by the gain calculated by the musical-noise-reduction-gain calculation unit and the noise component calculated by the noise estimation unit; and
a residual-noise-suppression-gain calculation unit that calculates a gain which is to be multiplied by the sound source signal obtained through the first beamformer processing unit and which is for suppressing a residual noise contained in the multiplication result of multiplying the sound source signal obtained through the first beamformer processing unit by the gain calculated by the musical-noise-reduction-gain calculation unit based on the gain calculated by the musical-noise-reduction-gain calculation unit and the noise component calculated by the noise equalizer,
wherein the sound source separation unit separates, from the mixed sounds, the sound source signal from the target sound source based on the multiplication result of multiplying the sound source signal obtained through the first beamformer processing unit by the gain calculated by the residual-noise-suppression-gain calculation unit.

7. The sound source separation device according to claim 6, comprising a control unit that controls at least one of the noise estimation unit, the noise equalizer unit, and the residual-noise-suppression gain calculation unit based on the weighting factor for each frequency.

8. The sound source separation device according to claim 1, comprising:
a reference delay amount calculation unit that calculates, for each frequency, a reference delay amount to be multiplied by an output signal by at least one microphone of the microphone pair to virtually shift a position of the microphone; and
a directivity control unit that gives a delay amount to an output signal by at least one microphone of the microphone pair for each frequency band,
wherein in a frequency band where the reference delay amount calculated by the reference delay amount calculation unit satisfies a spatial sampling theorem, the directivity control unit sets the reference delay amount to be the delay amount, and in a frequency band where the reference delay amount does not satisfy the spatial sampling theorem, the directivity control unit sets an optimized delay amount τ0 obtained from a following formula (30) to be the delay amount,
$$d + {τ}_{0} \cdot c = \frac{c π}{ω} ⇔ {τ}_{0} = \frac{π}{ω} - \frac{d}{c} \qquad ( 30 )$$
where d is a distance between the two microphones, c is a sound velocity, and ω is a frequency in the formula (30).

9. A sound source separation device that separates, from mixed sounds containing mixed sound source signals output by a plurality of sound sources, a sound source signal from a target sound source, the sound source separation device comprising:
first beamformer processing means for multiplying respective output signals by a microphone pair comprising two microphones into which the mixed sounds are input by different first coefficients, respectively, and performing a product-sum operation on obtained results in a frequency domain to attenuate a sound source signal arrived from a region opposite to a region including a direction of the target sound source with a plane intersecting with a line interconnecting the two microphones being as a boundary;
second beamformer processing means for multiplying respective output signals by the microphone pair by a second coefficient in a relationship of complex conjugate with the first coefficients different from each other in the frequency domain, and performing product-sum operation on an obtained result in the frequency domain to attenuate a sound source signal arrived from the region including the direction of the target sound source with the plane being as the boundary;
power calculation means for calculating first spectrum information having a power value for each frequency from a signal obtained through the first beamformer processing means, and further calculating second spectrum information having a power value for each frequency from a signal obtained through the second beamformer processing means;
weighting-factor calculation means for calculating, in accordance with a difference in the power values for each frequency between the first spectrum information and the second spectrum information, a weighting factor for each frequency to be multiplied by the signal obtained through the first beamformer processing means; and
sound source separation means for separating, from the mixed sounds, the sound source signal from the target sound source based on a multiplication result of the signal obtained through the first beamformer processing means by the weighting factor calculated by the weighting-factor calculation means.

10. The sound source separation device according to claim 9, further comprising weighting-factor multiplication means for multiplying the signal obtained through the first beamformer processing means by the weighting factor calculated by the weighting-factor calculation means,
wherein the sound source separation means separates, from the mixed sounds, the sound source signal from the target sound source based on a result of adding an output result by the weighting-factor multiplication means and the signal obtained through the first beamformer processing means at a predetermined ratio.

11. A sound source separation method executed by a sound source separation device comprising a first beamformer processing unit, a second beamformer processing unit, a power calculation unit, a weighting-factor calculation unit, and a sound source separation unit, the method comprising:
a first step of causing the first beamformer processing unit to perform, in a frequency domain using respective first coefficients different from each other, a product-sum operation on respective output signals by a microphone pair comprising two microphones into which mixed sounds containing mixed sound signals output by a plurality of sound sources are input to attenuate a sound source signal arrived from a region opposite to a region including a direction of a target sound source with a plane intersecting with a line interconnecting the two microphones being as a boundary;
a second step of causing the second beamformer processing unit to multiply respective output signals by the microphone pair by a second coefficient in a relationship of complex conjugate with the first coefficients different from each other in the frequency domain, and to perform a product-sum operation on an obtained result in the frequency domain to attenuate a sound source signal arrived from the region including the direction of the target sound source with the plane being as the boundary;
a third step of causing the power calculation unit to calculate first spectrum information having a power value for each frequency from a signal obtained through the first step, and to further calculate second spectrum information having a power value for each frequency from a signal obtained through the second step;
a fourth step of causing the weighting-factor calculation unit to calculate, in accordance with a difference in the power values for each frequency between the first spectrum information and the second spectrum information, a weighting factor for each frequency to be multiplied by the signal obtained through the first step; and
a fifth step of causing the sound source separation unit to separate, from the mixed sounds, a sound source signal from the target sound source based on a multiplication result of the signal obtained through the first step by the weighting factor calculated through the fourth step.

12. A program that causes a computer to execute:
a first process step of performing, in a frequency domain using respective first coefficients different from each other, a product-sum operation on respective output signals by a microphone pair comprising two microphones into which mixed sounds containing mixed sound signals output by a plurality of sound sources are input to attenuate a sound source signal arrived from a region opposite to a region including a direction of a target sound source with a plane intersecting with a line interconnecting the two microphones being as a boundary;
a second process step of multiplying respective output signals by the microphone pair by a second coefficient in a relationship of complex conjugate with the first coefficients different from each other in the frequency domain, and performing a product-sum operation on an obtained result in the frequency domain to attenuate a sound source signal arrived from the region including the direction of the target sound source with the plane being as the boundary;
a third process step of calculating first spectrum information having a power value for each frequency from a signal obtained through the first process step, and further calculating second spectrum information having a power value for each frequency from a signal obtained through the second process step;
a fourth process step of calculating, in accordance with a difference in the power values for each frequency between the first spectrum information and the second spectrum information, a weighting factor for each frequency to be multiplied by the signal obtained through the first process step; and
a fifth process step of separating, from the mixed sounds, a sound source signal from the target sound source based on a multiplication result of the signal obtained through the first process step by the weighting factor calculated through the fourth process step.
